(19) United States
(12) Patent Application Publication
(10) Pub. No.: US 2021/0304707 A1
(43) Pub. Date: Sep. 30, 2021

(54) DISPLAY CONTROL DEVICE AND DISPLAY CONTROL METHOD

(71) Applicant: Mitsubishi Electric Corporation, Tokyo (JP)

(72) Inventor: Yuko SUGANUMA, Tokyo (JP)

(73) Assignee: Mitsubishi Electric Corporation, Tokyo (JP)

(21) Appl. No.: 17/347,962

(22) Filed: Jun. 15, 2021

Related U.S. Application Data
(63) Continuation of application No. PCT/JP2019/001109, filed on Jan. 16, 2019.

(51) Int. Cl. G09G 5/36; G09G 5/373

(52) U.S. Cl. CPC G09G 5/363; G09G 2360/06; G09G 5/373

(57) ABSTRACT

Included are: a data acquiring unit for acquiring a design value indicating a value as a control target and an actual value indicating an actual measurement value for state information indicating states of a plurality of target areas; a graphic generating unit for generating a graphic indicating the design value and generating a graphic indicating the actual value on the basis of position coordinates of the generated graphic indicating the design value; and a display control unit for performing control to display the graphic indicating the design value and the graphic indicating the actual value that have been generated on a same screen of a display device for each of the target areas. The graphic generating unit generates the graphic indicating the design value and the graphic indicating the actual value using graphics that allow shapes thereof to be distinguished from each other when the graphic indicating the design value and the graphic indicating the actual value are superimposed and displayed while centers of gravity are matched.

### CROSS REFERENCE TO RELATED APPLICATION

This application is a Continuation of PCT International Application No. PCT/JP2019/001109, filed on Jan. 16, 2019, which is hereby expressly incorporated by reference into the present application.

### TECHNICAL FIELD

The present invention relates to technology for visualizing and displaying information indicating the state of a monitoring target.

### BACKGROUND ART

As technology for visualizing and displaying information indicating the state of a monitoring target, technology for displaying the power consumption as a bar chart or a line chart is provided, for example, in a system for monitoring the power consumption of a monitoring target.

For example, Patent Literature 1 discloses a demand management device for acquiring an actual value of power consumption used by a user for each predetermined time, determining whether or not a difference between the actual value and a planned value, which is a pre-planned consumption for each predetermined time that is prestored, exceeds a predetermined threshold value, and calculating a prediction value of a power consumption for each predetermined time in the future on the basis of the difference. In the demand management device, the actual value of the electric power consumption is illustrated by a bar chart, the planned value which is the planned consumption is illustrated by a line chart, and the bar chart and the line chart are superimposed and displayed, thereby displaying the actual value and the prediction value of the power consumption in a comparable manner.

### CITATION LIST

### Patent Literature

Patent Literature 1: JP 2018-102076 A

### SUMMARY OF INVENTION

### Technical Problem

In the demand management device described in Patent Literature 1 described above, it is possible to distinguish between two types of data, namely, an actual value and a prediction value of the power consumption. However, there is a problem that the number of charts displayed on one screen increases, thereby deteriorating the visibility in a case where the technology is applied to a system for monitoring a plurality of areas, for example, a system for monitoring the power consumption of a plurality of areas in a building or a plurality of floors of a building.

Regarding this problem, it is possible to display the charts by switching the screen for each of the plurality of areas; however, it is not easy to compare the power consumption of the plurality of areas. In addition, although it is possible to display the actual value and the prediction value of a plurality of areas on one screen by displaying both the actual value and the prediction value of the power consumption in line charts, the total number of line charts increases, and the visibility decreases in a case where the number of areas is large.

The present invention has been made to solve the above problems, and an object of the present invention is to display information indicating the state of a monitoring target in a plurality of areas on the same screen of a display device in an easily visually recognizable manner.

### Solution to Problem

A display control device according to the present invention includes: processing circuitry performing a process of: acquiring a design value indicating a value as a control target and an actual value indicating an actual measurement value for state information indicating states of a plurality of target areas; generating a graphic indicating the design value and generating a graphic indicating the actual value on a basis of position coordinates of the generated graphic indicating the design value; and performing control to display the graphic indicating the design value and the graphic indicating the actual value generated on a same screen of a display device for each of the target areas, wherein the process generates the graphic indicating the design value and the graphic indicating the actual value using graphics that allow shapes of the graphic indicating the design value and the graphic indicating the actual value to be distinguished from each other when the graphic indicating the design value and the graphic indicating the actual value are superimposed and displayed while centers of gravity are matched.

### Advantageous Effects of Invention

According to the present invention, it is possible to display information indicating the state of a monitoring target of a plurality of areas on the same screen of a display device in an easily visually recognizable manner.

### BRIEF DESCRIPTION OF DRAWINGS

FIG. 1 is a block diagram illustrating a configuration of a display control device according to a first embodiment.

FIGS. 2A and 2B are diagrams each illustrating an exemplary hardware configuration of the display control device according to the first embodiment.

FIG. 3 is a diagram illustrating an example of display control by the display control device according to the first embodiment.

FIG. 4 is a flowchart illustrating the operation of the display control device according to the first embodiment.

FIG. 5 is a flowchart illustrating the operation of a design value graphic generating unit of the display control device according to the first embodiment.

FIG. 6 is a flowchart illustrating the operation of an actual value graphic generating unit of the display control device according to the first embodiment.

FIG. 7 is a flowchart illustrating the operation of a display control unit of the display control device according to the first embodiment.

FIGS. 8A to 8G are diagrams illustrating specific examples of a process by the actual value graphic generating unit of the display control device according to the first embodiment.

FIGS. 9A and 9B are diagrams illustrating examples of display control of the display control device according to the first embodiment.

FIG. 10 is a block diagram illustrating the configuration of a display control device according to a second embodiment.

FIGS. 11A and 11B are diagrams illustrating the arrangement positions of graphics indicating related information by the display control device according to the second embodiment.

FIG. 12 is a flowchart illustrating the operation of the display control device according to the second embodiment.

FIG. 13 is a flowchart illustrating the operation of a related graphic generating unit of the display control device according to the second embodiment.

FIGS. 14A and 14B are diagrams illustrating examples of display colors of a graphic stored in a related graphic parameter storing unit of the display control device according to the second embodiment.

FIG. 15 is a flowchart illustrating the operation of a display control unit of the display control device according to the second embodiment.

FIG. 16 is a flowchart illustrating another operation of the related graphic generating unit of the display control device according to the second embodiment.

FIG. 17 is a diagram illustrating another display example of the display control device according to the second embodiment.

FIG. 18 is a block diagram illustrating the configuration of a display control device according to a third embodiment.

FIGS. 19A and 19B are diagrams illustrating examples of display control of the display control device according to the third embodiment.

FIG. 20 is a diagram illustrating an example of display control of the display control device according to the third embodiment.

FIG. 21 is a flowchart illustrating the operation of a design value graphic generating unit of the display control device according to the third embodiment.

FIG. 22 is a flowchart illustrating the operation of an actual value graphic generating unit of the display control device according to the third embodiment.

FIG. 23 is a flowchart illustrating the operation of a graphic transforming unit of the display control device according to the third embodiment.

### DESCRIPTION OF EMBODIMENTS

To describe the present invention further in detail, embodiments for carrying out the present invention will be described below with reference to the accompanying drawings.

### First Embodiment

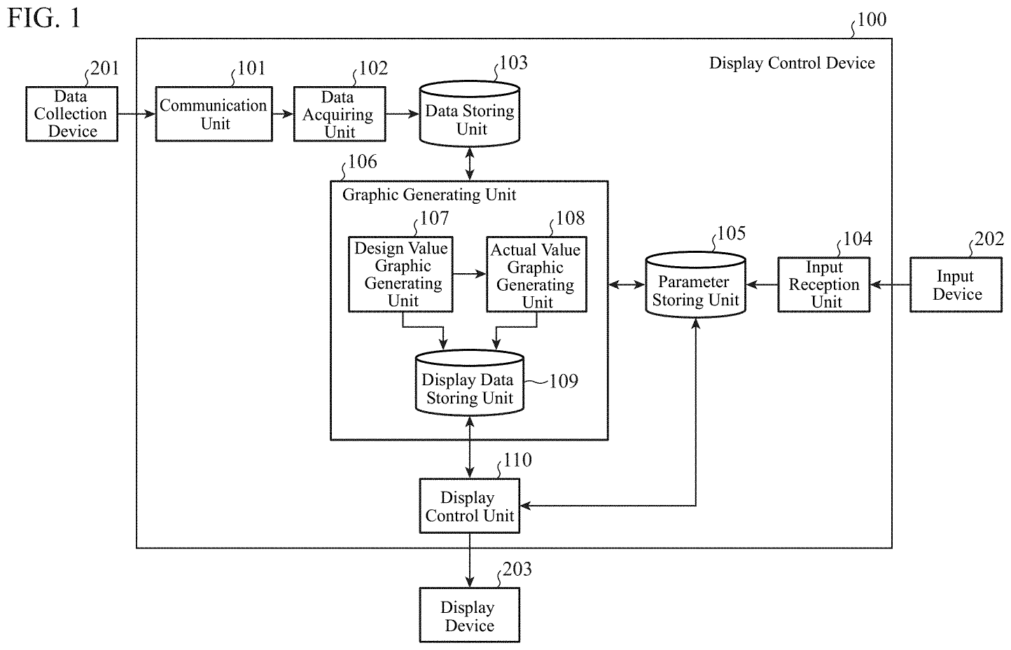

FIG. 1 is a block diagram illustrating the configuration of a display control device 100 according to a first embodiment.

The display control device 100 includes a communication unit 101, a data acquiring unit 102, a data storing unit 103, an input reception unit 104, a parameter storing unit 105, a graphic generating unit 106 including a design value graphic generating unit 107, an actual value graphic generating unit 108, and a display data storing unit 109, and a display control unit 110.

The display control device 100 is further connected with a data collection device 201, an input device 202, and a display device 203 that are external devices.

The data collection device 201 collects various types of data measured by sensors, for example. For example, in a case where the data collection device 201 collects various types of data of a building, the power consumption and various types of indoor and outdoor data (temperature, room temperature, humidity, illuminance, comfortableness, etc.) are collected. The data collection device 201 collects a target value for control (hereinafter referred to as a design value) in addition to the actual value on the basis of the type of data. Note that the data collection device 201 may use, as a design value, a value calculated by simulation. Incidentally, depending on the type of data, a design value is not always necessary data, and thus the data collection device 201 may not collect the design value.

The data collection device 201 is connected with the display control device 100 via a network. Here, wired communication using a communication cable, for example, or various types of wireless communication are applicable to the network.

The input device 202 includes an input device such as a mouse, a keyboard, a touch panel, or a graphical user interface (GUI). The display device 203 includes a display such as a liquid crystal display (LCD) and displays information generated by the display control device 100.

Next, each component of the display control device 100 will be described.

The communication unit 101 is a communication unit of, for example, a wired or wireless LAN or Bluetooth (registered trademark) and has a function of performing communication between the display control device 100 and the data collection device 201.

The data acquiring unit 102 acquires the actual value and a design value of information indicating the state of an area to be displayed that have been collected by the data collection device 201 via the communication unit 101.

Here, the area to be displayed includes, for example, a department, a meeting room, a floor, or the like and is hereinafter referred to as a target area. The information indicating the state of an area includes, for example, the room temperature, humidity, illuminance, air temperature, or comfortableness information and is hereinafter referred to as state information. The actual value includes an actual measurement value of the room temperature, humidity, illuminance, air temperature, etc. acquired by a sensor, for example. The design value is a preset value such as a target value or a recommended value when a device such as an air conditioner or a light is used.

The data acquiring unit 102 stores the acquired actual value and design value in the data storing unit 103 as actual value data and design value data in association with the state information and the target area.

The data storing unit 103 is an area for storing the actual value data and the design value data input from the data acquiring unit 102.

The input reception unit 104 receives input of a parameter via the input device 202. Here, a parameter is information for defining how to generate and to display a graphic when actual value data and design value data are displayed on the display device 203. The details of the parameters will be described later. The input reception unit 104 may further accept input of user operation on the information displayed on the display device 203.

The parameter storing unit 105 is an area for storing the parameter input from the input reception unit 104. The parameter storing unit 105 is also an area for storing a setting file including preset parameters.

The graphic generating unit 106 acquires the actual value data and the design value data of the state information from the data storing unit 103 and acquires parameters from the parameter storing unit 105. The graphic generating unit 106 generates two types of graphics, namely, a graphic indicating the actual value and a graphic indicating the design value that are related to each other. To be related with each other means that the position coordinates of the graphic indicating the actual value are determined by the position coordinates of the graphic indicating the design value. To be related with each other also means that the shapes of the graphic indicating the actual value and the graphic indicating the design value can be distinguished when the graphic indicating the actual value and the graphic indicating the design value are superimposed and displayed while the centers of gravity thereof are matched for each unit of the scale on the time axis. As described above, the graphic indicating the actual value and the graphic indicating the design value are related to each other in terms of the size and the inclusion state.

The graphic generating unit 106 includes the design value graphic generating unit 107, the actual value graphic generating unit 108, and the display data storing unit 109.

The design value graphic generating unit 107 acquires a parameter corresponding to a target area on the basis of the design value data acquired by the graphic generating unit 106. The design value graphic generating unit 107 generates a graphic indicating the design value for each unit time that has been preset, on the basis of the acquired parameter. Note that in a case where the cycle of data collection by the data collection device 201 is different from the unit of the time axis, such as each 30 minutes or each 10 minutes, the design value graphic generating unit 107 calculates a design value for the unit time of the scale using the collected data. The design value graphic generating unit 107 generates a graphic indicating the calculated design value.

The design value graphic generating unit 107 calculates the position coordinates of the generated graphic indicating the design value. The design value graphic generating unit 107 stores, in the display data storing unit 109, and outputs, to the actual value graphic generating unit 108, the position coordinates of the graphic indicating the calculated design value, the unit time of the time axis, and the target area.

The actual value graphic generating unit 108 adjusts the graphic indicating the design value that has been input from the design value graphic generating unit 107 on the basis of a parameter. The actual value graphic generating unit 108 calculates a ratio of the actual value indicated by the actual value data by referring to the design value for the graphic that has been adjusted, the unit time of the time axis input from the design value graphic generating unit 107, and the target area. The actual value graphic generating unit 108 generates a graphic indicating the actual value for each unit time that has been preset on the basis of the calculated ratio and the position coordinates of the adjusted graphic indicating the design value. The actual value graphic generating unit 108 calculates the position coordinates of the generated graphic indicating the actual value. The actual value graphic generating unit 108 stores the calculated position coordinates of the graphic indicating the actual value in the display data storing unit 109.

The display data storing unit 109 is a storage area for storing the position coordinates of the graphic indicating the design value input from the design value graphic generating unit 107, the unit time of the time axis, the target area, and the position coordinates of the graphic indicating the actual value input from the actual value graphic generating unit 108.

The display control unit 110 performs control to display the graphic indicating the design value and the graphic indicating the actual value on the display device 203 on the basis of the unit time of the time axis, the target area, the position coordinates of the graphic indicating the design value, and the position coordinates of the graphic indicating the actual value that are stored in the display data storing unit 109. The display control unit 110 acquires a parameter related to display from the parameter storing unit 105 and performs display control for displaying the graphics on the basis of the acquired parameter.

The display control unit 110 may accept user input for designating display conditions via the input reception unit 104. The user input for designating display conditions is operation of changing data to be displayed in the time axis direction by using the input device 202 such as a mouse. The user input for designating display conditions also includes operation of changing the unit of the scale on the time axis by using the input device 202 such as a keyboard. The user input for designating display conditions also includes operation of changing the display period for displaying on the display device 203 by using the input device 202 such as a GUI.

Upon receiving the user input for designating display conditions, the display control unit 110 changes the scale unit on the time axis, regenerates the graphic indicating the design value and the graphic indicating the actual value on the basis of the changed scale unit, and performs the control for displaying on the display device 203.

For example, in a case where the display device 203 is displaying a graphic indicating the design value and a graphic indicating the actual value after 8:00 Oct. 1, 2018 and when the display control unit 110 accepts user input of changing the scale unit on the time axis to “one month”, display control is performed to regenerate and display a graphic indicating the design value and a graphic indicating the actual value of each month such as October, November, December 2018, . . . .

Next, hardware configuration examples of the display control device 100 will be described.

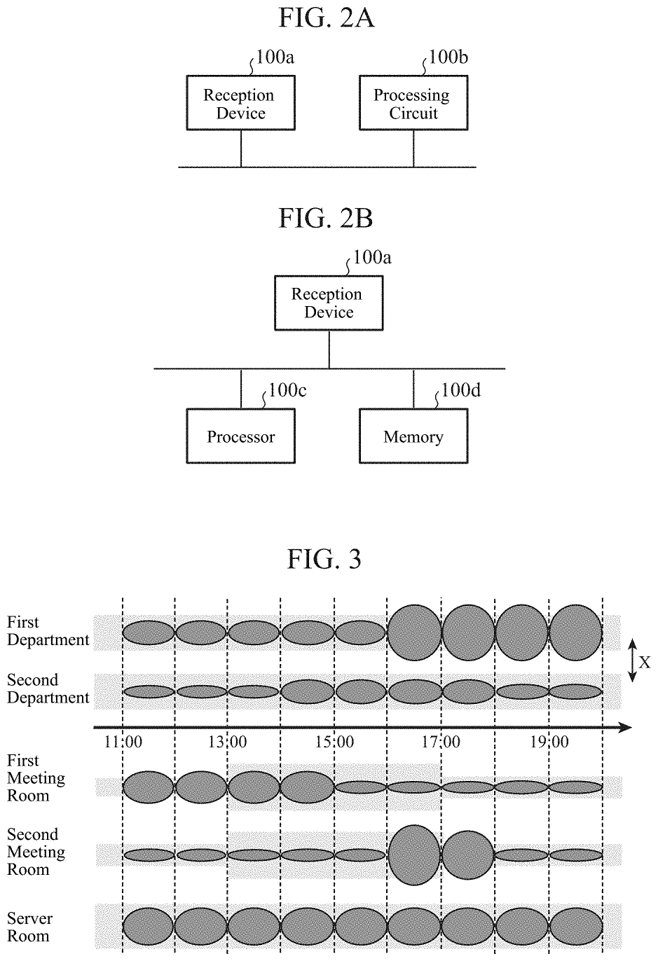

FIGS. 2A and 2B are diagrams each illustrating an exemplary hardware configuration of the display control device 100 according to the first embodiment.

The communication unit 101 in the display control device 100 corresponds to a reception device 100a that communicates with the data collection device 201. Each functions of the data acquiring unit 102, the input reception unit 104, the graphic generating unit 106, the design value graphic generating unit 107, the actual value graphic generating unit 108, and the display control unit 110 in the display control device 100 is implemented by a processing circuit. That is, the display control device 100 includes a processing circuit for implementing the above functions. The processing circuit may be a processing circuit 100b which is dedicated hardware as illustrated in FIG. 2A or may be a processor 100c for executing programs stored in a memory 100d as illustrated in FIG. 2B.

In the case where the data acquiring unit 102, the input reception unit 104, the graphic generating unit 106, the design value graphic generating unit 107, the actual value graphic generating unit 108, and the display control unit 110 are implemented by dedicated hardware as illustrated in FIG. 2A, the processing circuit 100b corresponds to, for example, a single circuit, a composite circuit, a programmed processor, a parallel-programmed processor, an application specific integrated circuit (ASIC), a field-programmable gate array (FPGA), or a combination thereof. The functions of the data acquiring unit 102, the input reception unit 104, the graphic generating unit 106, the design value graphic generating unit 107, the actual value graphic generating unit 108, and the display control unit 110 may be separately implemented by processing circuits or may be implemented collectively by a single processing circuit.

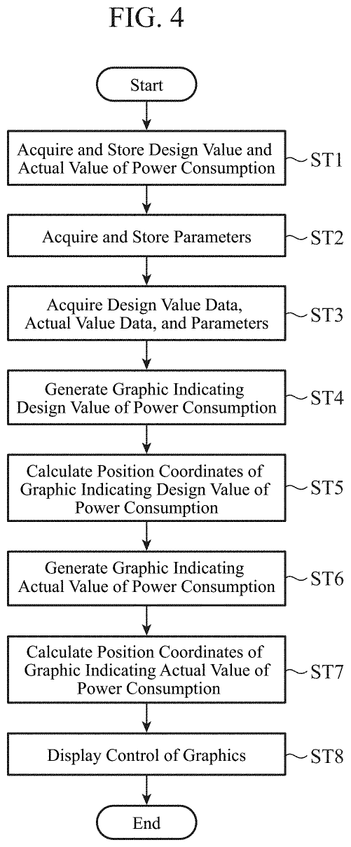

In the case where the data acquiring unit 102, the input reception unit 104, the graphic generating unit 106, the design value graphic generating unit 107, the actual value graphic generating unit 108, and the display control unit 110 correspond to the processor 100c as illustrated in FIG. 2B, the functions of the respective units are implemented by software, firmware, or a combination of software and firmware. The software or the firmware is described as a program and stored in the memory 100d. By reading out and executing the program stored in the memory 100d, the processor 100c implements the functions of the data acquiring unit 102, the input reception unit 104, the graphic generating unit 106, the design value graphic generating unit 107, the actual value graphic generating unit 108, and the display control unit 110. That is, the data acquiring unit 102, the input reception unit 104, the graphic generating unit 106, the design value graphic generating unit 107, the actual value graphic generating unit 108, and the display control unit 110 include the memory 100d for storing a program, execution of which by the processor 100c results in execution of steps illustrated in FIGS. 4 to 7 which will be described later. It can also be said that these programs cause a computer to execute procedures or methods of the data acquiring unit 102, the input reception unit 104, the graphic generating unit 106, the design value graphic generating unit 107, the actual value graphic generating unit 108, and the display control unit 110.

Here, the processor 100c may be, for example, a central processing unit (CPU), a processing device, an arithmetic device, a processor, a microprocessor, a microcomputer, a digital signal processor (DSP), or the like.

The memory 100d may be a nonvolatile or volatile semiconductor memory such as a random access memory (RAM), a read only memory (ROM), a flash memory, an erasable programmable ROM (EPROM), an electrically EPROM (EEPROM); a magnetic disk such as a hard disk or a flexible disk, or an optical disk such as a mini disk, a compact disc (CD), or a digital versatile disc (DVD).

Note that a part of the functions of the data acquiring unit 102, the input reception unit 104, the graphic generating unit 106, the design value graphic generating unit 107, the actual value graphic generating unit 108, and the display control unit 110 may be implemented by dedicated hardware, and another part thereof may be implemented by software or firmware. In this manner, the processing circuit 100b in the display control device 100 can implement the above functions by hardware, software, firmware, or a combination thereof.

FIG. 3 is a diagram illustrating an example of display control by the display control device 100 according to the first embodiment.

Illustrated in FIG. 3 is an example in which the design value and the actual value of power consumption for each unit time of the scale on the time axis are displayed for each target area. State information is power consumption. Target areas are a first department, a second department, a first meeting room, a second meeting room, and a server room. The unit time of the scale on the time axis is one hour. Target areas displayed above the time axis are the first department and the second department. Target areas displayed below the time axis are the first meeting room, the second meeting room, and the server room.

The graphic indicating the design value of power consumption is a rectangle, and the graphic indicating the actual value of power consumption is an ellipse or a circle. One rectangle and one ellipse are displayed per unit time, or one rectangle and one circle are displayed per unit time.

A time period in which the length in the height direction of an ellipse is smaller than the length in a direction orthogonal to the time axis of the rectangles (hereinafter referred to as the height direction, the direction of arrow X in FIG. 3) illustrates that the actual value of power consumption is lower than the design value. Conversely, a time period in which the length in the height direction of an ellipse is larger than the length in the height direction of the rectangle illustrates that the actual value of power consumption is higher than the design value.

Details of parameters stored in the parameter storing unit 105 will be described.

The parameter storing unit 105 stores parameters input via the input reception unit 104 or a setting file in which parameters are set in advance. The parameters stored in the parameter storing unit 105 are described below. Note that the parameters described below are examples, and parameters can be added or deleted as appropriate.

Target period parameter: Period for which a graphic indicating the design value and a graphic indicating the actual value are generated.

Time axis parameter: Unit of the scale of the time axis to be displayed.

Maximum number of graduations parameter: Maximum number of graduations on the time axis to be displayed.

Target area parameter: Unit of target area (for example, displaying by area, displaying by floor, or displaying by building).

Design value graphic parameter: Setting values of a graphic indicating the design value (for example, the minimum and maximum values of the height of the rectangle when the design value is displayed as a rectangle).

Threshold value parameter: threshold value for the absolute value of the difference between the design value and the actual value in each piece of state information.

Width offset parameter: Offset of the width of the graphic indicating the design value.

Height offset parameter: Offset of the height of the graphic indicating the design value.

Display parameter: Information for setting at least one of the color of the graphic indicating the design value and the graphic indicating the actual value, the display order, whether to display or to hide the graphics, or the transparency.

Arrangement parameter: Information for designating whether to arrange each piece of state information above or below the time axis.

A target period parameter indicates a period for which the graphic indicating the design value and the graphic indicating the actual value are generated (hereinafter referred to as a target period). A user sets the parameter as desired via the input device 202, for example, from January 2017 to March 2018.

The time axis parameter indicates the unit of the scale of the time axis to be displayed. The parameter may be set as desired such as by hour, by day, by week, by month, or by year.

In the case of the display example illustrated in FIG. 3, it is an example of displaying the time series state of a day, and the unit of the scale of the time axis, that is, the unit of auxiliary lines, is one hour. The unit of the scale may be two hours or three hours and can be set desirably. Meanwhile, in a case where the time series state of one month is displayed, the unit of the scale may be by week such as one week or two weeks.

The maximum number of graduations parameter is the maximum number of graduations to be displayed in the time axis direction. The maximum number of graduations parameter is desirably set by the user via the input device 202. In a case where the time axis parameter is “day”, the user sets, for example, “14” or “31” as the maximum number of graduations parameter.

The target area parameter is the unit of area for analyzing and displaying state information.

In the case of the display example illustrated in FIG. 3, the units of target areas are the “first department”, the “second department”, the “first meeting room”, the “second meeting room”, and the “server room”. The units of areas can be set by floor or by building, for example. In the case of the display example illustrated in FIG. 3, each of the “first department”, the “second department”, the “first meeting room”, the “second meeting room”, and the “server room” is a target area. In a case where the unit of areas is, for example, by floor, each floor such as the first floor, the second floor, and the third floor are target areas.

The design value graphic parameter is used when the design value graphic generating unit 107 generates a graphic. The design value graphic generating unit 107 calculates the height of the graphic indicating the design value using a range from the minimum value to the maximum value defined in the design value graphic parameter.

The threshold value parameter is used when the actual value graphic generating unit 108 generates a graphic. The actual value graphic generating unit 108 calculates the height of the graphic indicating the actual value on the basis of the relationship between the absolute value of the difference between the design value data and the actual value data and a threshold value defined in the threshold value parameter.

The width offset parameter and the height offset parameter are used when the actual value graphic generating unit 108 generates a graphic.

The display parameter indicates the display color of the graphic indicating the design value and the graphic indicating the actual value. The display parameter also indicates whether to display or to hide the graphic indicating the design value and the graphic indicating the actual value. The display control unit 110 displays, for example, only the graphic indicating the design value on the basis of the display parameter. The display parameter also indicates the display order of the graphic indicating the design value and the graphic indicating the actual value. The display control unit 110 displays, for example, the graphic indicating the design value and then displays the graphic indicating the actual value on the basis of the parameter. The display parameter also indicates the transparency of the graphic indicating the design value and the graphic indicating the actual value. The display control unit 110 displays, for example, the graphic indicating the actual value over the graphic indicating the design value at a transparency of 50% on the basis of the parameter.

The arrangement parameter indicates whether to display each of the target areas above or below the time axis display. In the case of the display example illustrated in FIG. 3, it is defined that the target areas “first department” and “second department” are displayed above the time axis display. Meanwhile, it is defined that the target areas “first meeting room”, “second meeting room”, and “server room” are displayed below the time axis display.

Apart from the display example illustrated in FIG. 3, for example, in an office building, departments that are residential rooms are displayed above the time axis display, and shared areas such as meeting rooms are displayed below the time axis display. In this manner, whether to display above or below the time axis display may be determined on the basis of the attribute of a target area. In a case where target areas are floors of a building, for example, target areas of “floors on and above the ground” are displayed above the time axis display, and “underground floors” are displayed below the time axis. Note that the arrangement parameter is not limited to the above examples.

Next, the operation of the display control device 100 will be described.

FIG. 4 is a flowchart illustrating the operation of the display control device 100 according to the first embodiment.

In the following, in order to visualize the information indicating the state of power consumption of a building, the case of displaying the power consumption of each target area will be described as an example. Note that the parameters are set by a user via the input device 202 and stored in the parameter storing unit 105 via the input reception unit 104. Described as an example is a case where a rectangular graphic is displayed as the graphic indicating the design value and an ellipse or a circular graphic is displayed as the graphic indicating the actual value.

The data acquiring unit 102 acquires the design value and the actual value of the power consumption of each of the target areas collected by the data collection device 201 via the communication unit 101 and stores the design value and the actual value in the data storing unit 103 (step ST1). In step ST1, the data acquiring unit 102 stores the acquired actual value and design value in the data storing unit 103 as actual value data and design value data in association with the state information and the target areas. The input reception unit 104 acquires the parameters input via the input device 202 and stores the parameters in the parameter storing unit 105 (step ST2). The graphic generating unit 106 acquires the design value data and the actual value data stored in the data storing unit 103 and acquires the parameters stored in the parameter storing unit 105 (step ST3).

The design value graphic generating unit 107 generates a graphic indicating the design value of the power consumption on the basis of the parameters acquired in step ST3 (step ST4). The design value graphic generating unit 107 calculates the position coordinates of the graphic indicating the design value of the power consumption generated in step ST4, outputs the calculated position coordinates, the unit time of the time axis, and the target areas to the actual value graphic generating unit 108 and stores them in the display data storing unit 109 (step ST5).

The actual value graphic generating unit 108 generates a graphic indicating the actual value of the power consumption on the basis of the parameters acquired in step ST3 and the position coordinates of the graphic indicating the design value of the power consumption output in step ST5 (step ST6). The actual value graphic generating unit 108 calculates the position coordinates of the graphic indicating the actual value of the power consumption generated in step ST6 and stores the position coordinates in the display data storing unit 109 (step ST7). The display control unit 110 acquires the position coordinates, the unit time of the time axis, and the target areas stored in steps ST5 and ST7 from the display data storing unit 109, performs display control of the graphic indicating the design value of the power consumption and the graphic indicating the actual value of the power consumption (step ST8), and ends the process.

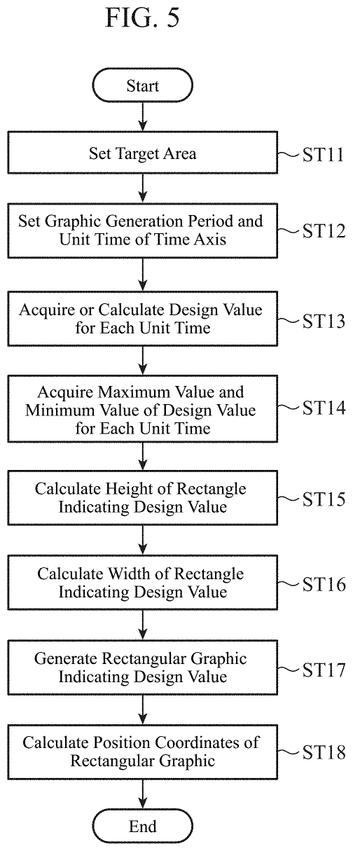

Next, the details of the processes illustrated in the flowchart of FIG. 4 will be described by referring to the flowcharts of FIGS. 5 to 7.

FIG. 5 is a flowchart illustrating the operation of the design value graphic generating unit 107 of the display control device 100 according to the first embodiment.

The details of the operation of the design value graphic generating unit 107 illustrated in steps ST4 and ST5 of the flowchart of FIG. 4 will be described by referring to FIG. 5.

The design value graphic generating unit 107 sets target areas on the basis of the design value data acquired by the graphic generating unit 106 (step ST11). The design value graphic generating unit 107 sets a period for which a graphic is to be generated and the unit time of the time axis on the basis of the target period parameter and the time axis parameter acquired by the graphic generating unit 106 (step ST12).

The design value graphic generating unit 107 acquires or calculates the design value from the design value data for each of the target areas for each unit time set in step ST12 (step ST13). The design value graphic generating unit 107 acquires the maximum value and the minimum value from all the design values of all the target areas acquired in step ST13 (step ST14). The design value graphic generating unit 107 calculates the height of the rectangle indicating the design value for each unit time so that the maximum value and the minimum value of the design value acquired in step ST14 are within a range of a design value graphic parameter acquired by the graphic generating unit 106 (step ST15). The design value graphic generating unit 107 calculates the width of the rectangle representing the design value on the basis of a maximum number of graduations parameter acquired by the graphic generating unit 106 (step ST16).

The design value graphic generating unit 107 generates a rectangular graphic indicating the design value on the basis of the height of the rectangle calculated in step ST15 and the width of the rectangle calculated in step ST16 (step ST17). The design value graphic generating unit 107 calculates the position coordinates of the rectangular graphic generated in step ST17, stores the position coordinates in the display data storing unit 109 together with the unit time of the time axis and the target areas, and outputs the position coordinates to the actual value graphic generating unit 108 (step ST18).

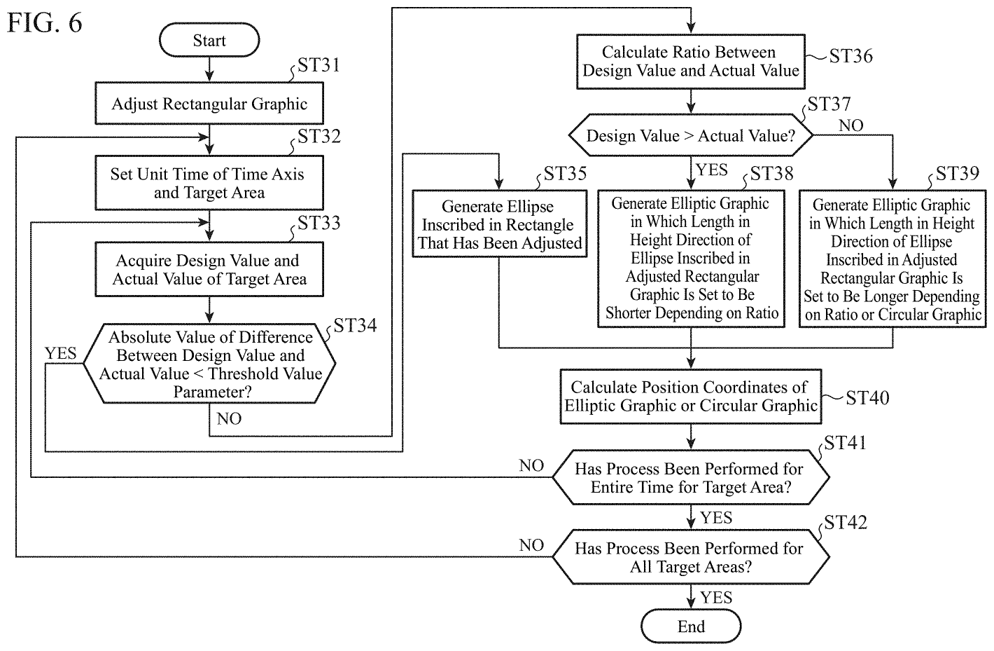

FIG. 6 is a flowchart illustrating the operation of the actual value graphic generating unit 108 of the display control device 100 according to the first embodiment.

The details of the operation of the actual value graphic generating unit 108 illustrated in steps ST6 and ST7 of the flowchart of FIG. 4 will be described by referring to FIG. 6.

The actual value graphic generating unit 108 adjusts the rectangular graphic indicating the design value on the basis of the position coordinates of the rectangular graphic input from the design value graphic generating unit 107, a width offset parameter, and a height offset parameter (step ST31). The actual value graphic generating unit 108 sets the unit time of the time axis and the target areas input from the design value graphic generating unit 107 (step ST32). The actual value graphic generating unit 108 acquires the design value and the actual value of the target areas set in step ST32 for each unit time from the design value data and the actual value data acquired by the graphic generating unit 106 (step ST33).

The actual value graphic generating unit 108 compares the absolute value of the difference between the design value and the actual value acquired in step ST33 with a threshold value parameter and determines whether or not the absolute value of the difference between the design value and the actual value is less than the threshold value parameter (step ST34). If the absolute value of the difference between the design value and the actual value is less than the threshold value parameter (step ST34: YES), the actual value graphic generating unit 108 generates an elliptical graphic inscribed in the rectangular graphic adjusted in step ST31 (step ST35). On the other hand, if the absolute value of the difference between the design value and the actual value is not less than the threshold value parameter (step ST34: NO), the actual value graphic generating unit 108 calculates the ratio between the design value and the actual value (step ST36).

The actual value graphic generating unit 108 determines whether or not the design value is larger than the actual value (step ST37). If the design value is larger than the actual value (step ST37: YES), the actual value graphic generating unit 108 generates an elliptical graphic in which the length in the height direction of the ellipse inscribed in the rectangular graphic adjusted in step ST31 is set to be shorter depending on the ratio calculated in step ST36 (step ST38). On the other hand, if the design value is not larger than the actual value (step ST37: NO), the actual value graphic generating unit 108 generates an elliptical graphic in which the length in the height direction of the ellipse inscribed in the rectangular graphic adjusted in step ST31 is set to be longer depending on the ratio calculated in step ST36 or a circular graphic (step ST39).

The actual value graphic generating unit 108 calculates the position coordinates of the elliptical graphic or the circular graphic generated in step ST35, step ST38, or step ST39 and stores the position coordinates in the display data storing unit 109 (step ST40). The actual value graphic generating unit 108 determines whether or not the process has been performed for the entire time for the target area that is being processed (step ST41). If the process has not been performed for the entire time for the target area that is being processed (step ST41: NO), the actual value graphic generating unit 108 returns to the process of step ST33 and repeats the above-described process.

On the other hand, if the process has been performed for the entire time for the target area that is being processed (step ST41: YES), the actual value graphic generating unit 108 determines whether or not the process has been performed for all the target areas (step ST42). If the process has not been performed for all the target areas (step ST42: NO), the actual value graphic generating unit 108 returns to the process of step ST32 and repeats the above-described process. On the other hand, if the process has been performed for all the target areas (step ST42: YES), the actual value graphic generating unit 108 ends the process.

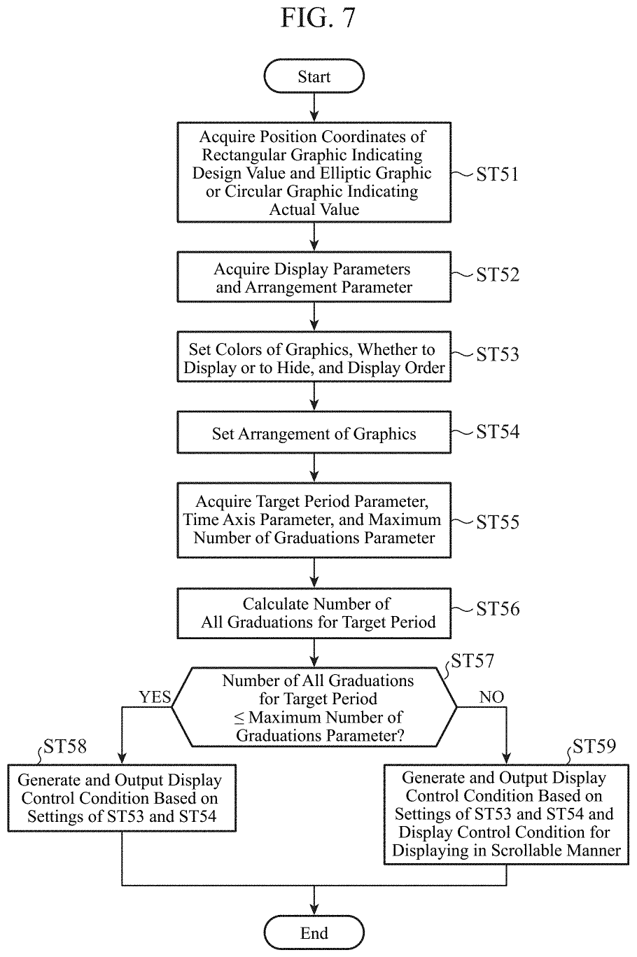

FIG. 7 is a flowchart illustrating the operation of the display control unit 110 of the display control device 100 according to the first embodiment.

The details of the operation of the display control unit 110 illustrated in step ST8 of the flowchart of FIG. 4 will be described by referring to FIG. 7.

Note that, in the example of FIG. 7, it is assumed that information indicating the color of the graphic indicating the design value and the graphic indicating the actual value, the display order, and whether to display or to hide the graphics is set as display parameters.

The display control unit 110 acquires the position coordinates of the rectangular graphic indicating the design value stored in the display data storing unit 109 and the position coordinates of the elliptical graphic or the circular graphic indicating the actual value (step ST51). The display control unit 110 acquires the display parameters and an arrangement parameter from the parameter storing unit 105 (step ST52). The display control unit 110 sets the colors of the rectangular graphic indicating the design value and the elliptical graphic or the circular graphic indicating the actual value, whether to display or to hide the graphics, and the display order on the basis of the display parameters acquired in step ST52 (step ST53). The display control unit 110 sets whether to arrange graphics of each of the target areas above the time axis or below the time axis on the basis of the arrangement parameter acquired in step ST52 (step ST54).

The display control unit 110 acquires a target period parameter, a time axis parameter, and a maximum number of graduations parameter from the parameter storing unit 105 (step ST55). The display control unit 110 calculates the number of all graduations in a target period using the target period parameter and the time axis parameter (step ST56). The display control unit 110 determines whether or not the number of all graduations in the target period calculated in step ST56 is less than or equal to the value of the maximum number of graduations parameter (step ST57). If the number of all graduations in the target period is less than or equal to the value of the maximum number of graduations parameter (step ST57: YES), the display control unit 110 generates and outputs, to the display device 203, display control conditions based on the settings of step ST53 and step ST54 (step ST58) and ends the process.

On the other hand, if the number of all graduations in the target period is not less than or equal to the value of the maximum number of graduations parameter (step ST57: NO), the display control unit 110 generates display control conditions based on the settings of step ST53 and step ST54, generates and outputs, to the display device 203, the display control conditions for displaying the display information in a scrollable manner on the time axis (step ST59), and ends the process.

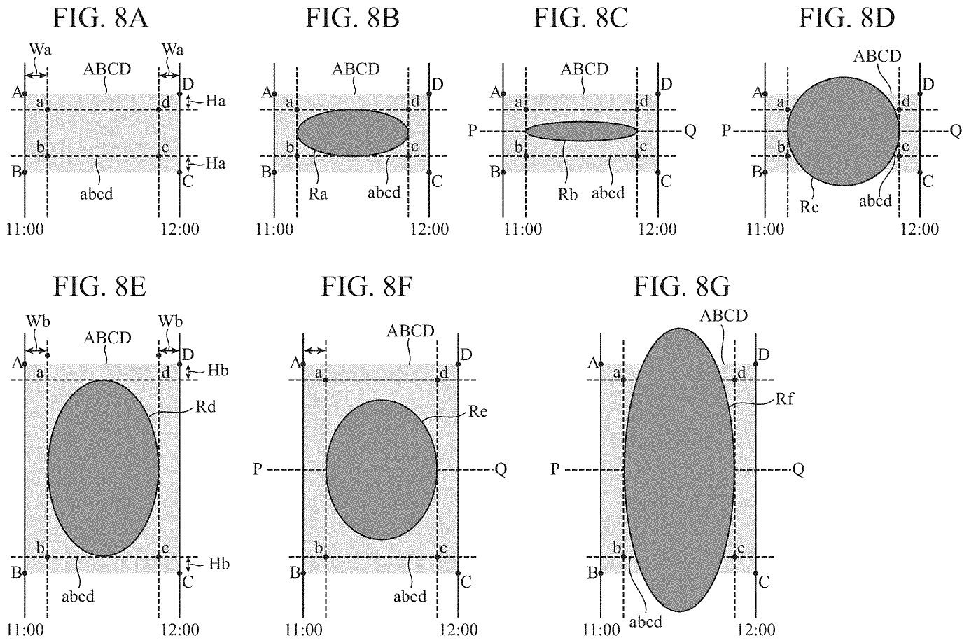

FIGS. 8A to 8G are diagrams illustrating specific examples of the process by the actual value graphic generating unit 108 of the display control device 100 according to the first embodiment. The process illustrated in FIGS. 8A to 8G is the process illustrated in the flowchart illustrated in FIG. 6 described above.

FIG. 8A is a diagram illustrating an example in which the actual value graphic generating unit 108 adjusts a rectangular graphic indicating the design value on the basis of the width offset parameter and the height offset parameter.

The time period is from 11:00 to 12:00, and the rectangular graphic generated by the design value graphic generating unit 107 for the time period is rectangle ABCD. The actual value graphic generating unit 108 performs adjustment to reduce the width of rectangle ABCD on the basis of a width offset value Wa indicated by the width offset parameter.

The actual value graphic generating unit 108 also performs adjustment to reduce the height of rectangle ABCD on the basis of a height offset value Ha indicated by the height offset parameter. The actual value graphic generating unit 108 generates rectangle abcd by the above adjustment.

FIG. 8B is a diagram illustrating an example in which the actual value graphic generating unit 108 generates elliptical graphic Ra inscribed in rectangle abcd in a case where the absolute value of the difference between the design value and the actual value is less than the threshold value parameter (step ST34 in FIG. 6: YES).

FIG. 8C is a diagram illustrating an example in which the actual value graphic generating unit 108 generates an elliptical graphic in which the length in the height direction of the ellipse inscribed in the rectangular graphic is shortened depending on the ratio between the design value and the actual value in a case where the absolute value of the difference between the design value and the actual value is not less than the threshold value parameter (step ST34 in FIG. 6: NO) and the design value is larger than the actual value (step ST37 in FIG. 6: YES).

The actual value graphic generating unit 108 disposes the center of elliptical graphic Rb on line segment PQ that bisects rectangle abcd in the height direction. The generated elliptical graphic Rb contacts sides ab and dc of rectangle abcd but does not contact side ad or bc. As described above, in the case of FIG. 8C, a part of the outer circumference of the generated elliptical graphic Rb is positioned inside rectangle abcd.

FIG. 8D is a diagram illustrating an example in which the actual value graphic generating unit 108 generates elliptical graphic Rc in which the length in the height direction of the elliptical graphic inscribed in rectangle abcd is elongated depending on the ratio between the design value and the actual value in a case where the absolute value of the difference between the design value and the actual value is not less than the threshold value parameter (step ST34 in FIG. 6: NO) and the design value is not larger than the actual value (step ST37 in FIG. 6: NO). The actual value graphic generating unit 108 disposes the center of elliptical graphic Rc on line segment PQ that bisects rectangle abcd in the height direction. The generated elliptical graphic Rc contacts sides ab and dc of rectangle abcd but does not contact side ad or bc. In the case of FIG. 8D, a part of the outer circumference of the generated elliptical graphic Rc is positioned outside rectangle abcd.

Although the case where the widths of rectangle ABCD and rectangle abcd are larger than the heights thereof is illustrated in FIGS. 8A to 8D, the widths of rectangle ABCD and rectangle abcd may be smaller than the heights thereof. FIGS. 8E to 8G are explanatory diagrams illustrating a case where the widths of rectangle ABCD and rectangle abcd are smaller than the heights.

FIG. 8E is a diagram illustrating a case where the actual value graphic generating unit 108 performs adjustment to reduce the width of rectangle ABCD on the basis of the width offset value Wb indicated by the width offset parameter. The actual value graphic generating unit 108 further performs adjustment to reduce the height of rectangle ABCD on the basis of the height offset value Hb indicated by the height offset parameter. FIG. 8E is also a diagram illustrating an example in which the actual value graphic generating unit 108 generates elliptical graphic Rd inscribed in rectangle abcd in a case where the absolute value of the difference between the design value and the actual value is less than the threshold value parameter (step ST34 in FIG. 6: YES).

FIG. 8F is a diagram illustrating an example in which the actual value graphic generating unit 108 generates elliptical graphic Re in which the length in the height direction of the elliptical graphic inscribed in rectangle abcd is shortened depending on the ratio between the design value and the actual value in a case where the absolute value of the difference between the design value and the actual value is not less than the threshold value parameter (step ST34 in FIG. 6: NO) and the design value is larger than the actual value (step ST37 in FIG. 6: YES). The actual value graphic generating unit 108 disposes the center of ellipse Re on line segment PQ that bisects rectangle abcd in the height direction. The generated elliptical graphic Re contacts sides ab and dc of rectangle abcd but does not contact side ad or bc. As described above, in the case of FIG. 8F, a part of the outer circumference of the generated elliptical graphic Re is positioned inside rectangle abcd.

FIG. 8G is a diagram illustrating an example in which the actual value graphic generating unit 108 generates elliptical graphic Rf in which the length in the height direction of the elliptical graphic inscribed in rectangle abcd is elongated depending on the ratio between the design value and the actual value in a case where the absolute value of the difference between the design value and the actual value is not less than the threshold value parameter (step ST34 in FIG. 6: NO) and the design value is not larger than the actual value (step ST37 in FIG. 6: NO). The actual value graphic generating unit 108 disposes the center of ellipse Rf on line segment PQ that bisects rectangle abcd in the height direction. The generated elliptical graphic Rf contacts sides ab and dc of rectangle abcd but does not contact side ad or bc. As described above, in the case of FIG. 8G, a part of the outer circumference of the generated elliptical graphic Rf is positioned outside rectangle abcd.

In the above description, the actual value graphic generating unit 108 compares the absolute value of the difference between the design value and the actual value with the threshold value parameter; however, the comparison using the threshold value parameter may not be performed.

In that case, the actual value graphic generating unit 108 calculates the ratio of the actual value to the design value (ratio=actual value/design value). The actual value graphic generating unit 108 adjusts the rectangular graphic input from the design value graphic generating unit 107 on the basis of the width offset parameter and the height offset parameter. The actual value graphic generating unit 108 calculates the major axis and the minor axis of the elliptical graphic or the radius of the circular graphic on the basis of the adjusted rectangular graphic (rectangle abcd in FIG. 8A) and the calculated ratio and calculates the position coordinates of the elliptical graphic or the circular graphic.
In a case where the ratio=1.0 (design value=actual value)

The actual value graphic generating unit 108 generates an elliptical graphic inscribed in the rectangular graphic adjusted on the basis of the width offset parameter and the height offset parameter (for example, FIG. 8B).
In a case where the ratio>1.0 (actual value>design value)

The actual value graphic generating unit 108 generates an elliptical graphic or a circular graphic that expands beyond the rectangular graphic adjusted on the basis of the width offset parameter and the height offset parameter. The actual value graphic generating unit 108 determines the major axis and the minor axis of the elliptical graphic to be generated or the radius of the circular graphic depending on a ratio (for example, FIG. 8D).
In a case where the ratio<1.0 (actual value<design value)

The actual value graphic generating unit 108 generates an elliptical graphic or a circular graphic that is accommodated inside the rectangular graphic adjusted on the basis of the width offset parameter and the height offset parameter. The actual value graphic generating unit 108 determines the major axis and the minor axis of the elliptical graphic to be generated or the radius of the circular graphic depending on a ratio (for example, FIG. 8C).

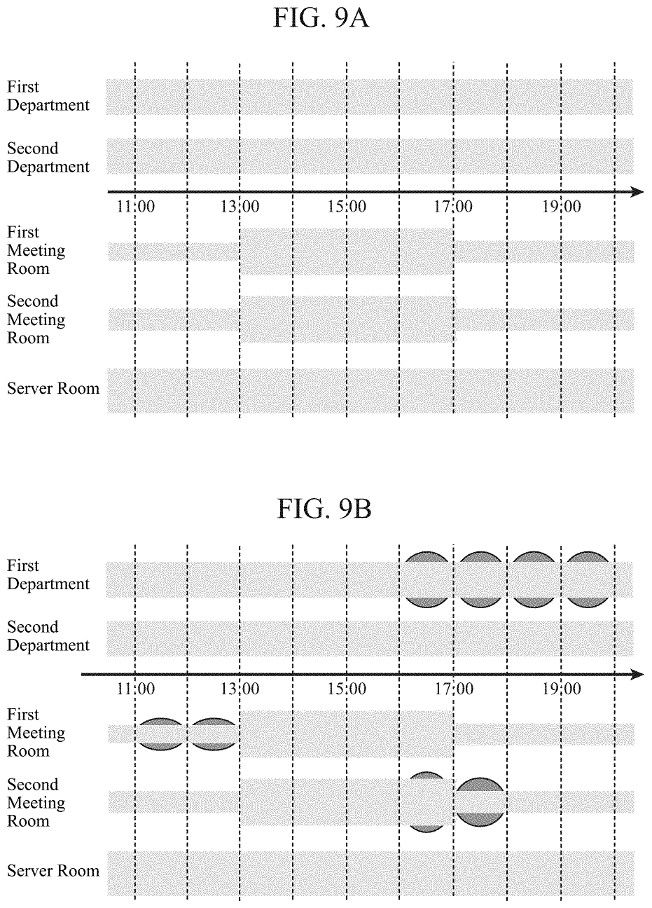

FIGS. 9A and 9B are diagrams illustrating examples of display control of the display control device 100 according to the first embodiment.

Illustrated in FIG. 9A is a case where the display control unit 110 displays the graphic indicating the design value and hides the graphic indicating the actual value on the basis of another parameter of whether to display or to hide the graphics among the display parameters. In addition, in the case illustrated, the display control unit 110 displays the first department and the second department, which are target areas, above the time axis on the basis of the arrangement parameter and displays the first meeting room, the second meeting room, and the server room, which are target areas, below the time axis.

Illustrated in FIG. 9B is a case where the display control unit 110 displays the graphic indicating the design value after displaying the graphic indicating the actual value on the basis of the parameter of the display order among the display parameters. By displaying the graphic indicating the design value later, it is possible to easily grasp time periods in which the actual value exceeds the design value. In FIG. 9B, the display control unit 110 may change the transparency of the graphic indicating the design value on the basis of the parameter indicating the transparency among the display parameters.

The display control unit 110 may perform control to display the graphic indicating the design value and the graphic indicating the actual value by being scrolled in the time axis direction in response to user operation that is input via the input reception unit 104.

The display control unit 110 may also change the unit time of the time axis on the basis of the setting file stored in the parameter storing unit 105 or user operation that is input via the input device 202.

The display control unit 110 may also perform control to display information by reducing the size so that the entire designated period is displayed within one screen of the display device 203 on the basis of a display period designated by user operation that is input via the input device 202.

The display control unit 110 may change the state information and the target areas currently displayed on the display device 203 in accordance with user operation that is input via the input reception unit 104. For example, in the case where the target areas are five areas of the “first department”, the “second department”, the “first meeting room”, the “second meeting room”, and the “server room” in the display example illustrated in FIG. 3, the display control unit 110 may perform display control to change the target areas to only the “first department” in accordance with user operation.

Alternatively, in the display example illustrated in FIG. 3, the display control unit 110 may change the target areas to each floor and may perform display control to change target areas to floors such as a “first floor”, a “second floor”, and a “third floor”. In this case, it is assumed that the display data storing unit 109 stores position coordinates of a graphic indicating the design value and a graphic indicating the actual value for each floor.

Further alternatively, in the display example illustrated in FIG. 3, the display control unit 110 may set, as a target area, each of a plurality of buildings that is managed and may perform control to display a graphic indicating the design value and a graphic indicating the actual value of each of the buildings.

As described above, according to the first embodiment, included are: the data acquiring unit 102 for acquiring a design value indicating a value as a control target and an actual value indicating an actual measurement value for state information indicating states of a plurality of target areas; the graphic generating unit 106 for generating a graphic indicating the design value and generating a graphic indicating the actual value on the basis of position coordinates of the generated graphic indicating the design value; and the display control unit 110 for performing control to display the graphic indicating the design value and the graphic indicating the actual value that have been generated on the same screen of the display device 203 for each of the target areas, and the graphic generating unit 106 generates the graphic indicating the design value and the graphic indicating the actual value using graphics that allow shapes thereof to be distinguished from each other when the graphic indicating the design value and the graphic indicating the actual value are superimposed and displayed while centers of gravity are matched.

As a result, it is possible to display information indicating the state of a plurality of target areas on the same screen of the display device 203 in an easily visually recognizable manner.

Further according to the first embodiment, the graphic generating unit 106 includes: the design value graphic generating unit 107 for generating the graphic indicating the design value by calculating the height of the graphic indicating the design value so that the maximum value and the minimum value of the design value are within a range of a preset parameter for each unit time of the time axis to be displayed and calculating the width of the graphic indicating the design value depending on the unit time of the time axis and calculating the position coordinates of the generated graphic indicating the design value; and the actual value graphic generating unit 108 for calculating the position coordinates of the graphic indicating the actual value using the position coordinates of the graphic indicating the design value for each unit time of the time axis on the basis of a difference between the design value and the actual value or a ratio of the actual measurement value to the design value, and the display control unit 110 performs control to display the graphic indicating the design value and the graphic indicating the actual value for each of the target areas on the basis of the position coordinates of the graphic indicating the design value calculated by the design value graphic generating unit 107 and the position coordinates of graphic indicating the actual value calculated by the actual value graphic generating unit 108.

As a result, the relationship between the design value and the actual value can be displayed in a small area for each unit time of the time axis in an easily visually recognizable manner. It is further possible to display time-series changes of the design value and the actual value on the same screen of the display device 203 for the plurality of target areas in an easily visually recognizable manner.

Further according to the first embodiment, the actual value graphic generating unit 108 calculates the size of the graphic indicating the actual value on the basis of a ratio of the actual value to the design value in a case where the difference between the design value and the actual value is larger than a preset threshold value.

Further according to the first embodiment, the actual value graphic generating unit 108 calculates the size of the graphic indicating the actual value on the basis of a ratio of the actual value to the design value.

As a result, the relationship between the design value and the actual value can be displayed for each unit time of the time axis in an easily visually recognizable manner. It is further possible to display time-series changes of the design value and the actual value for the plurality of target areas in an easily visually recognizable manner.

### Second Embodiment

In a second embodiment, in addition to the configuration described in the first embodiment above, a component for displaying a graphic that is related to a graphic indicating the design value and a graphic indicating the actual value is described.

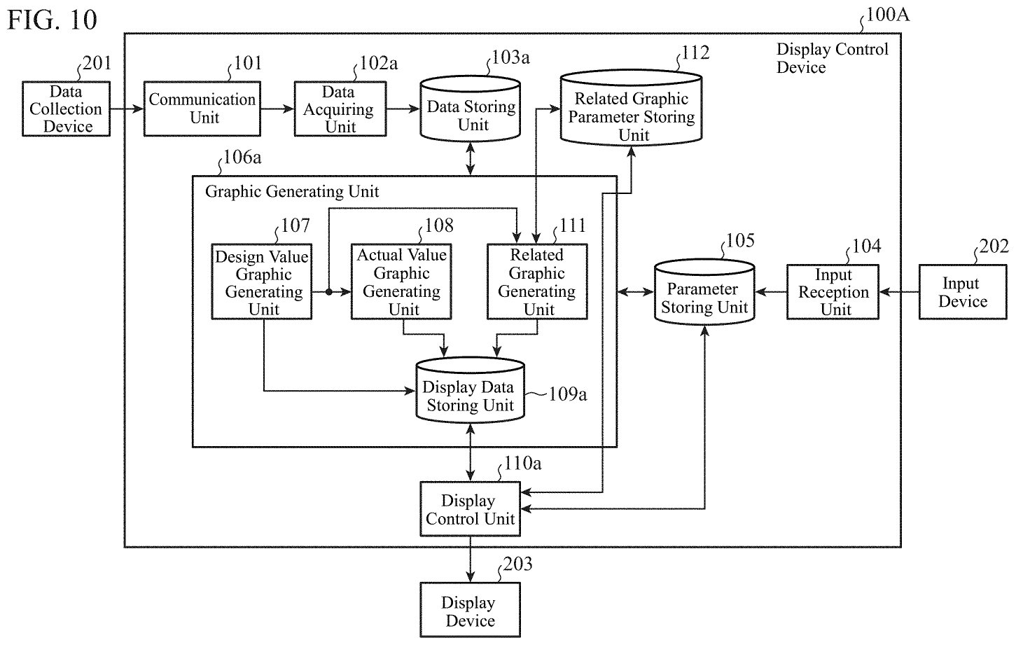

FIG. 10 is a block diagram illustrating the configuration of a display control device 100A according to the second embodiment.

The display control device 100A of the second embodiment is implemented by adding a related graphic generating unit 111 and a related graphic parameter storing unit 112 to the display control device 100 illustrated in the first embodiment. Furthermore, instead of the data acquiring unit 102, the data storing unit 103, the graphic generating unit 106, the display data storing unit 109, and the display control unit 110 illustrated in the first embodiment, a data acquiring unit 102a, a data storing unit 103a, a graphic generating unit 106a, a display data storing unit 109a, and a display control unit 110a are included.

Note that, in the following description, the same symbol as that used in the first embodiment is provided to the same or a corresponding component as that of the display control device 100 according to the first embodiment, and explanation thereof is omitted or simplified.

In addition to the configuration illustrated in the first embodiment, the data acquiring unit 102a further acquires information related to the design value and the actual value (hereinafter, referred to as related information). Here, the information related to the design value and the actual value is, for example, information indicating the comfort level of a target area, information indicating the temperature, or information indicating the number of people present in the target area in a case where the display control device 100A performs control to display the design value and the actual value indicating the power consumption of the target area. The data acquiring unit 102a associates the acquired related information with the target area and stores the related information in the data storing unit 103a as related data.

The data storing unit 103a is an area for storing related data input from the data acquiring unit 102a in addition to the actual value data and the design value data illustrated in the first embodiment.

The graphic generating unit 106a includes the related graphic generating unit 111 in addition to the design value graphic generating unit 107, the actual value graphic generating unit 108, and the display data storing unit 109a.

The related graphic generating unit 111 refers to the unit time of the time axis input from the design value graphic generating unit 107 and information of target areas and sets the target areas and the unit time of the time axis. The related graphic generating unit 111 analyzes the related data acquired from the data storing unit 103a for each unit time that has been set on the basis of an analytical criterion stored in the related graphic parameter storing unit 112. The related graphic generating unit 111 generates a graphic indicating the related information on the basis of the analysis result of the related data and display parameters of the related graphic acquired from the related graphic parameter storing unit 112. The related graphic generating unit 111 calculates the position coordinates of the graphic indicating the related information on the basis of the position coordinates of the graphic indicating the design value input from the design value graphic generating unit 107. The related graphic generating unit 111 stores, in the display data storing unit 109a, the position coordinates of the graphic indicating the related information that has been calculated.

The display data storing unit 109a is a storage area for storing the position coordinates of the graphic indicating the related information in addition to the position coordinates of the graphic indicating the design value, the position coordinates of the graphic indicating the actual value, the unit time of the time axis, and the target areas that have been illustrated in the first embodiment.

The related graphic parameter storing unit 112 is an area for storing an analytical criterion setting how to analyze related data, display parameters of the graphic indicating the related information, and an arrangement parameter of the graphic indicating the related information. Here, the analytical criterion is information indicating under what conditions the related data is analyzed for each unit time of the time axis. For example, in a case where the unit time of the time axis is one hour, stored as the analytical criterion is information indicating that one of the average value, the maximum value, or the minimum value of the related data for every hour is calculated and that the calculated value is analyzed.

Meanwhile, the display parameters of the related graphic contain information for setting the shape of the graphic indicating the related information, the size of the graphic indicating the related information, and the display color of the graphic indicating the related information. Furthermore, an arrangement parameter of the related graphic contains information indicating the arrangement position of the graphic indicating the related information. The arrangement parameter of the related graphic contains, for example, information for arranging the graphic indicating the related information at the bottom of either the graphic indicating the design value or the graphic indicating the actual value for each of the target areas for each unit time.

The related graphic parameter storing unit 112 stores parameters input via an input reception unit 104 or a setting file in which parameters are set in advance.

The display control unit 110a performs control to display the graphic indicating the design value, the graphic indicating the actual value, and the graphic indicating the related information on a display device 203 on the basis of the position coordinates of the graphic indicating the design value, the position coordinates of the graphic indicating the actual value, the position coordinates of the graphic indicating the related information, the unit time of the time axis, and the target areas that have been stored in the display data storing unit 109a. The display control unit 110a performs display control for displaying graphics on the basis of the display parameters and the arrangement parameter acquired from the parameter storing unit 105 and the display parameters of the related graphic and the arrangement parameter of the related graphic acquired from the related graphic parameter storing unit 112.

Hardware configuration examples of the display control device 100A will be described. Note that description of the same configuration as that of the first embodiment is omitted.

The data acquiring unit 102a, the graphic generating unit 106a, the display control unit 110a, and the related graphic generating unit 111 in the display control device 100A correspond to the processing circuit 100b illustrated in FIG. 2A or the processor 100c that executes a program stored in the memory 100d illustrated in FIG. 2B.

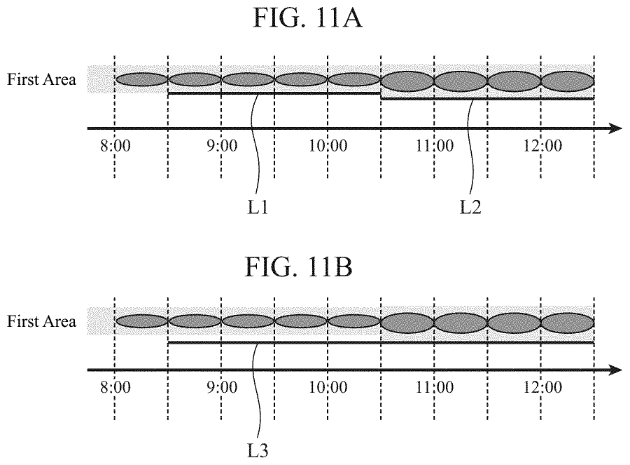

FIG. 11 is a diagram illustrating the arrangement positions of a graphic indicating related information by the display control device 100A according to the second embodiment.

The display control unit 110a disposes the graphic indicating the related information at a preset position according to either the size of a graphic indicating the design value or the size of a graphic indicating the actual value. Moreover, as for the shape of the graphic indicating the related information, a shape that is different from the shape of the graphic indicating the design value or the shape of the graphic indicating the actual value is set on the basis of a parameter.

FIG. 11A is a diagram illustrating a case where a line segment, which is a graphic indicating related information, is disposed at the bottom of the graphic indicating the design value for each unit time. In FIG. 11A, since the size of the graphic indicating the design value is different for each unit time, the position where the graphic indicating the related information is disposed varies depending on a time period. The related graphic generating unit 111 disposes line segment L1 at the bottom of the graphic indicating the design value in the time period from 8:00 to 10:30. Similarly, the related graphic generating unit 111 disposes line segment L2 at the bottom of the graphic indicating the design value in the time period from 10:30 to 12:30.

FIG. 11B is a diagram illustrating a case where a line segment, which is a graphic indicating the related information, is disposed while extended and at the bottom of the graphic indicating the maximum design value in all time periods. The related graphic generating unit 111 disposes line segment L3 by extending line segment L3 at the bottom of the graphic having the highest height among all the graphics indicating the design value in the time period from 8:00 to 12:30.

Note that, in FIGS. 11A and 11B, in a case where the size of the graphic indicating the actual value is larger than the size of the graphic indicating the design value, the line segment, which is the graphic indicating the related information may be disposed at a preset position, for example, at the bottom of the graphic indicating the actual value depending on the size of the graphic indicating the actual value.

Note that the related graphic generating unit 111 can also draw the line segment, which is the graphic indicating the related information, over the graphic indicating the design value or the graphic indicating the actual value.

Next, the operation of the display control device 100A will be described.

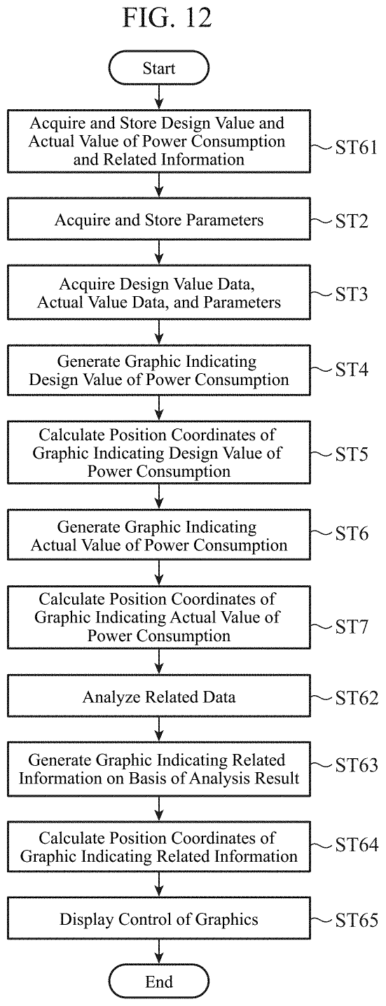

FIG. 12 is a flowchart illustrating the operation of the display control device 100A according to the second embodiment.

In FIG. 12, the same steps as those in the flowchart of the first embodiment illustrated in FIG. 4 are denoted by the same symbol, and description thereof will be omitted.

The data acquiring unit 102a acquires the design value of the power consumption of each target item, the actual value of the power consumption of each target item, and related information of the design value and the actual value that are collected by the data collection device 201 via the communication unit 101 and stores them in the data storing unit 103 (step ST61).

After the display control device 100A performs the processes from step ST2 to step ST7, the related graphic generating unit 111 acquires related data from the data storing unit 103a and analyzes the related data acquired on the basis of an analytical criterion stored in the related graphic parameter storing unit 112 (step ST62). The related graphic generating unit 111 generates a graphic indicating the related information on the basis of the analysis result obtained in step ST62 (step ST63). The related graphic generating unit 111 calculates the position coordinates of the graphic indicating the related information generated in step ST63 and stores the position coordinates in the display data storing unit 109a (step ST64). The display control unit 110a acquires the position coordinates stored in steps ST5, ST7, and ST64, the unit time of the time axis, and the target areas from the display data storing unit 109a, performs display control of the graphic displaying the design value of the power consumption, the graphic displaying the actual value of the power consumption, and the graphic displaying the related information (step ST65), and ends the process.

Next, the operation of the related graphic generating unit 111 illustrated in steps ST62 to ST64 of the flowchart of FIG. 12 will be described.

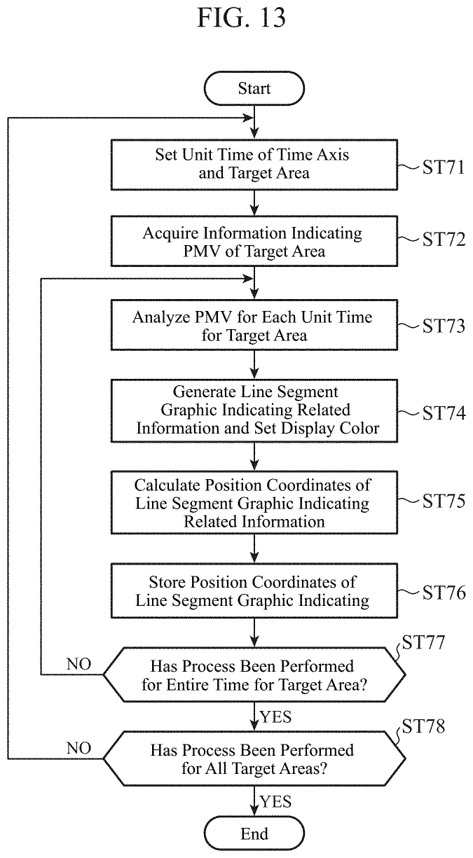

FIG. 13 is a flowchart illustrating the operation of the related graphic generating unit 111 of the display control device 100A according to the second embodiment.

In the following, a case will be illustrated as an example in which the related graphic generating unit 111 generates, as a graphic indicating related information, a graphic indicating a predicted mean vote (PMV) that indicates a comfort index of a target area.

The related graphic generating unit 111 refers to the unit time of the time axis and information of target areas input from the design value graphic generating unit 107 and sets the target areas and the unit time of the time axis (step ST71). The related graphic generating unit 111 acquires information indicating the PMV of the target areas as related information from the data storing unit 103a (step ST72). The related graphic generating unit 111 analyzes the PMV of the target areas for each unit time on the basis of an analytical criterion stored in the related graphic parameter storing unit 112 (step ST73). For example, in a case where the analytical criterion is the average value of PMVs for each unit time, the related graphic generating unit 111 calculates the average value of PMVs of the first department from 11:00 to 12:00 when the target area that is currently being processed is the “first department” and the time period that is currently being processed is “11:00 to 12:00”.

The related graphic generating unit 111 generates a line segment graphic indicating the related information on the basis of the analysis result of step ST73 and display parameters of the related graphic stored in the related graphic parameter storing unit 112 and sets the display color of the line segment graphic (step ST74). The related graphic generating unit 111 calculates the position coordinates of the line segment graphic indicating the related information generated in step ST74 (step ST75). The related graphic generating unit 111 stores the position coordinates of the line segment graphic indicating the related information calculated in step ST75 and the color information of the line segment graphic in the display data storing unit 109a (step ST76). The related graphic generating unit 111 determines whether or not the process has been performed for the entire time for the target area that is being processed (step ST77). If the process has not been performed for the entire time for the target area that is being processed (step ST77: NO), the related graphic generating unit 111 returns to the process of step ST73 and repeats the above-described process.

On the other hand, if the process has been performed for the entire time (step ST77: YES), the related graphic generating unit 111 determines whether or not the process has been performed for all the target areas (step ST78). If the process has not been performed for all the target areas (step ST78: NO), the related graphic generating unit 111 returns to the process of step ST71 and repeats the above-described process. On the other hand, if the process has been performed for all the target areas (step ST78: YES), the related graphic generating unit 111 ends the process.

The setting of the display color of the line segment graphic illustrated in step ST74 of the flowchart of FIG. 13 described above will be described in more detail.

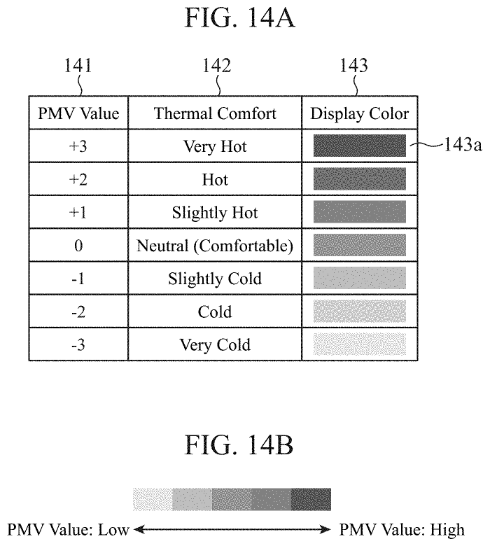

The related graphic generating unit 111 refers to information of display colors of a graphic set in advance for each value of the PMV and sets the display color of the line segment graphic on the basis of the value of the PMV analyzed in step ST73. It is assumed that the information of preset display colors of a graphic is stored in the related graphic parameter storing unit 112. An example of the information of preset display colors is illustrated in FIG. 14.

FIG. 14 is a diagram illustrating examples of display colors of a graphic stored in the related graphic parameter storing unit 112 of the display control device 100A according to the second embodiment.

In FIG. 14A, PMV values 141 of seven stages, information indicating the degree of thermal comfort 142 corresponding to the PMV values, and display colors 143 of the graphic corresponding to the PMV values are associated with each other. In a case where the PMV value 141 is “+3”, the information indicating the degree of thermal comfort 142 is “very hot”, and it is indicated that the graphic is set to a display color 143a. In FIG. 14A, the case where the display color varies among seven stages in association with the seven stages of the PMV value has been illustrated; however, the PMV value and the number of stages of the display color can be set as desired.

Illustrated in FIG. 14B is an example in which the display color varies among five stages depending on the magnitude of the PMV value. Note that the display colors of the respective stages illustrated in FIGS. 14A and 14B, for example, RGB values, can be set as desired.

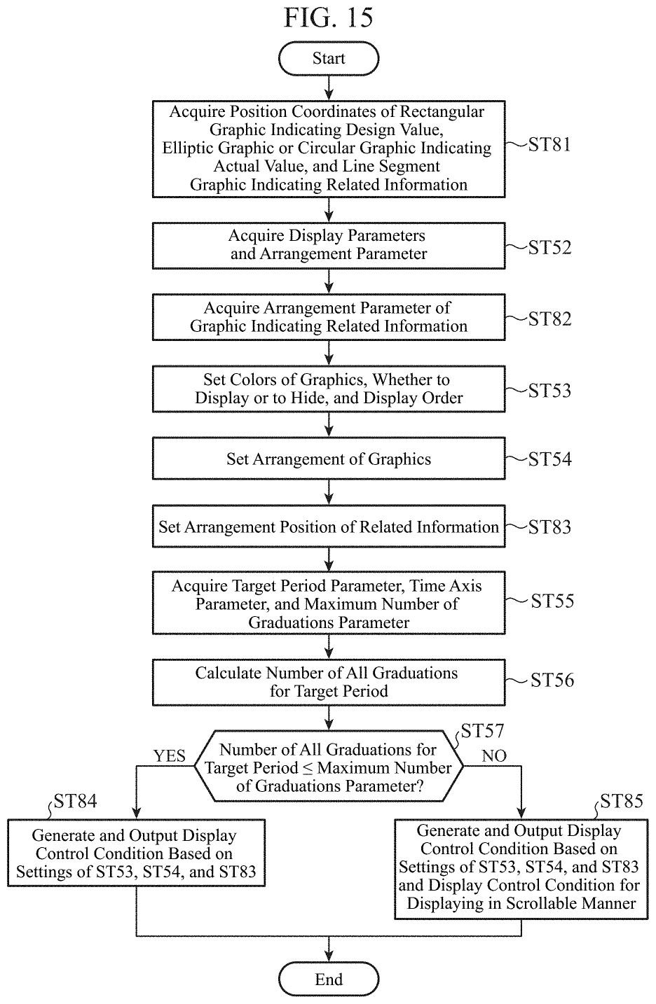

FIG. 15 is a flowchart illustrating the operation of the display control unit 110a of the display control device 100A according to the second embodiment.

The details of the operation of the display control unit 110a illustrated in step ST65 of the flowchart of FIG. 12 will be described by referring to FIG. 15.

Note that, in FIG. 15, the same steps as those in the flowchart of the first embodiment illustrated in FIG. 7 are denoted by the same symbol, and description thereof will be omitted.

Furthermore, in the example of FIG. 15, it is assumed that information indicating the color of the graphic indicating the design value and the graphic indicating the actual value, the display order, and whether to display or to hide the graphics is set as display parameters. It is also assumed that information indicating the arrangement of the graphic indicating the design value and the graphic indicating the actual value, and the arrangement of the graphic indicating the related information are set as an arrangement parameter.

The display control unit 110a acquires the position coordinates of the rectangular graphic indicating the design value, the position coordinates of an elliptical graphic or a circular graphic indicating the actual value, and the position coordinates of a line segment graphic indicating the related information stored in the display data storing unit 109a (step ST81). The display control unit 110a acquires the display parameters and the arrangement parameter of the graphic indicating the design value and the graphic indicating the actual value from the parameter storing unit 105a (step ST52). The display control unit 110a acquires the arrangement parameter of the graphic indicating the related information from the related graphic parameter storing unit 112 (step ST82). The display control unit 110a sets the colors of the rectangular graphic indicating the design value and the elliptical graphic or the circular graphic indicating the actual value, whether to display or to hide the graphics, and the display order on the basis of the display parameters acquired in step ST52 (step ST53).

The display control unit 110a sets whether to arrange each of the target areas above the time axis or below the time axis on the basis of the arrangement parameter acquired in step ST52 (step ST54). The display control unit 110a sets the arrangement position of the related information on the basis of the arrangement parameter acquired in step ST82 (step ST83).

The display control unit 110 acquires a target period parameter, a time axis parameter, and a maximum number of graduations parameter from the parameter storing unit 105 (step ST55). The display control unit 110 calculates the number of all graduations in a target period using the target period parameter and the time axis parameter (step ST56). The display control unit 110 determines whether or not the number of all graduations in the target period calculated in step ST56 is less than or equal to the value of the maximum number of graduations parameter (step ST57). If the number of all graduations in the target period is less than or equal to the value of the maximum number of graduations parameter (step ST57: YES), the display control unit 110 generates and outputs, to the display device 203, display control conditions based on the settings of step ST53, step ST54, and step ST83 (step ST84) and ends the process.

On the other hand, if the number of all graduations in the target period is not less than or equal to the value of the maximum number of graduations parameter (step ST57: NO), the display control unit 110 generates display control conditions based on the settings of step ST53, step ST54, and step ST83 and also generates and outputs, to the display device 203, display control conditions for displaying the display information in a scrollable manner on the time axis (step ST85), and ends the process.

In the flowchart of FIG. 13 described above, the case has been described in which the related graphic generating unit 111 analyzes only the PMVs that indicate the comfort index as one piece of related information; however, two or more pieces of related information may be analyzed. For example, since the comfort of a target area is an important index for areas where a person is present, the related graphic generating unit 111 generates a graphic indicating the PMV only for a time period when a person is present. A process will be described below in which the related graphic generating unit 111 analyzes information indicating the number of people present in a target area (first related information) and information indicating the comfort level of the target area (second related information) and generates a graphic indicating the related information.

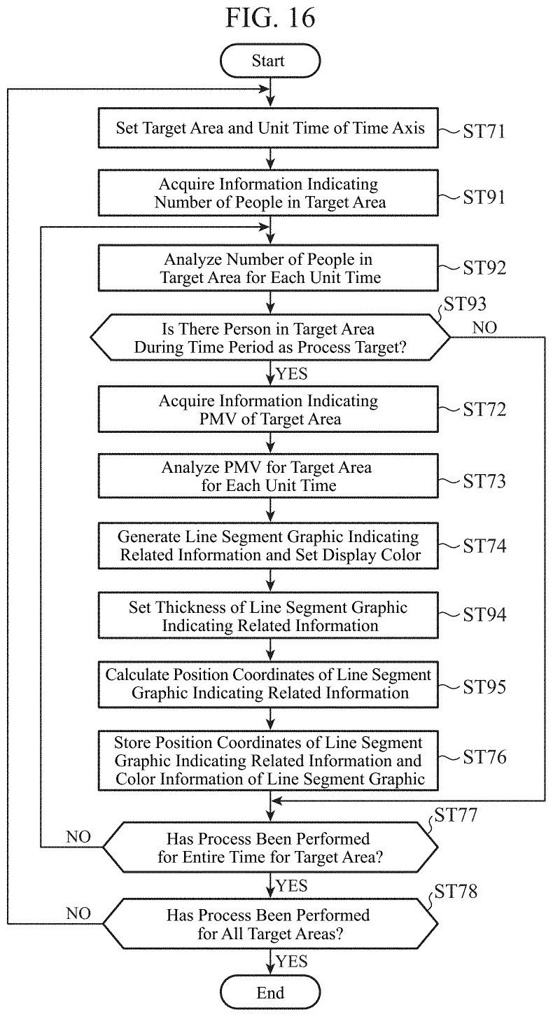

FIG. 16 is a flowchart illustrating other operation of the related graphic generating unit 111 of the display control device 100A according to the second embodiment.

In FIG. 16, the same steps as those in the flowchart illustrated in FIG. 13 are denoted by the same symbol, and description thereof will be omitted.

The related graphic generating unit 111 refers to the unit time of the time axis and the information of the target areas input from the design value graphic generating unit 107 and sets the units of the time axis and the target areas (step ST71). The related graphic generating unit 111 acquires information indicating the number of people in the target areas as related information from the data storing unit 103a (step ST91). The related graphic generating unit 111 analyzes the number of people in the target areas for each unit time on the basis of an analytical criterion stored in the related graphic parameter storing unit 112 (step ST92). For example, in a case where the analytical criterion is the average value of the number of people for each unit time, the related graphic generating unit 111 calculates the average value of the number of people of the first department from 11:00 to 12:00 when the target area that is currently being processed is the “first department” and the time period that is currently being processed is “11:00 to 12:00”.

The related graphic generating unit 111 refers to the analysis result of step ST92 and determines whether or not there is a person in the target area in the time period to be processed (step ST93). If there is no person (step ST93: NO), the related graphic generating unit 111 proceeds to the process of step ST77. On the other hand, if there is a person (step ST93: YES), the related graphic generating unit 111 performs the process from step ST72 to step ST74. Next, the related graphic generating unit 111 sets the thickness of the line segment graphic generated in step ST74 on the basis of the analysis result in step ST92 (step ST94). In the process of step ST94, for example, the related graphic parameter storing unit 112 stores information in which values of the thickness of the line segment graphic are set depending on the number of people present in a target area. In this information, it is set to increase the thickness of the line segment graphic as the number of people increases, such as to set the thickness of the line segment graphic to 2 pt when the number of people in the target area is one to five and to set the thickness of the line segment graphic to 4 pt when the number of people in the target area is six to ten. The related graphic generating unit 111 sets the thickness of the line segment graphic by referring to the information, in which the value of the thickness of the line segment graphic is set, stored in the related graphic parameter storing unit 112.

The related graphic generating unit 111 calculates the position coordinates of the line segment graphic indicating the related information in which the thickness has been set in step ST94 (step ST95). The related graphic generating unit 111 stores, in the display data storing unit 109a, the position coordinates of the line segment graphic indicating the related information calculated in step ST95 and the color information of the line segment graphic set in step ST74 (step ST76). The related graphic generating unit 111 determines whether or not the process has been performed for the entire time for the target area that is being processed (step ST77). If the process has not been performed for the entire time for the target area that is being processed (step ST77: NO), the related graphic generating unit 111 returns to the process of step ST92 and repeats the above-described process.

On the other hand, if the process has been performed for the entire time (step ST77: YES), the related graphic generating unit 111 determines whether or not the process has been performed for all the target areas (step ST78). If the process has not been performed for all the target areas (step ST78: NO), the related graphic generating unit 111 returns to the process of step ST71 and repeats the above-described process. On the other hand, if the process has been performed for all the target areas (step ST78: YES), the related graphic generating unit 111 ends the process.

Note that the process of setting the thickness of the line segment graphic illustrated in step ST94 described above is not an essential process and may be omitted.

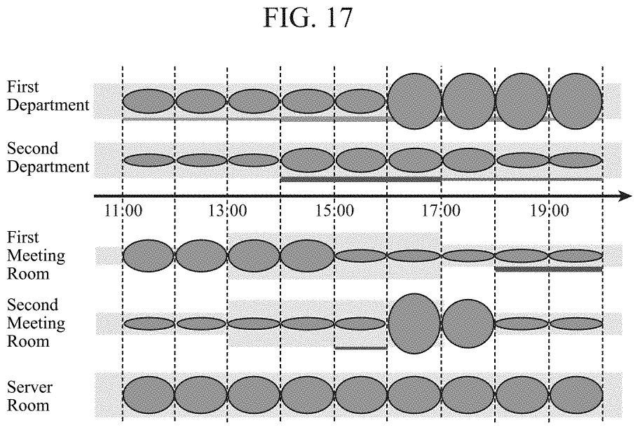

Since the process of controlling the display of the graphic indicating the related information that has been generated in the flowchart of FIG. 16 described above is the same as the process operation illustrated in the flowchart of FIG. 15, the description thereof will be omitted. Illustrated in FIG. 17 is a display example when a graphic indicating related information is displayed in accordance with the flowchart of FIG. 16.

FIG. 17 is a diagram illustrating another display example of the display control device 100A according to the second embodiment.

In FIG. 17, a line segment graphic indicating the related information is disposed at the bottom of the graphic indicating the design value for each unit time. In addition, a line segment graphic indicating the related information indicates the comfort level by the change in the color of the line segment and is disposed depending on the number of people present in the target area, and the thickness of the line segment graphic is determined depending on the number of people.

The display relating to the target area “first meeting room” illustrated in FIG. 17 indicates the following contents.
The number of people present is “zero” during the time period from 11:00 to 18:00.
During the time period from 18:00 to 20:00, the actual value is less than the design value; however, the PMV value is “+3”, and thus the thermal comfort is in the state of very hot.

Note that the information on the thermal comfort of “very hot” is obtained on the basis of the information indicating the degree of thermal comfort 142 illustrated in FIG. 14A. Moreover, the color of the line segment is determined on the basis of the information on the thermal comfort.
During the time period from 11:00 to 13:00, the actual value exceeds the design value by a preset threshold value or more.

As illustrated in FIG. 17, since the related graphic generating unit 111 generates a graphic indicating the related information only when there is a person in the target area, it is possible to appropriately display information that is necessary for the user.

Note that, the process of analyzing two pieces of related information, namely, PMVs and information indicating the number of people, and generating a graphic indicating the related information has been illustrated as an example in the above description; however, the number of pieces of related information is not limited to two, and related information is not limited to PMVs or information indicating the number of people.

As described above, according to the second embodiment, the data acquiring unit 102a acquires related information related to the design value and the actual value, and the graphic generating unit 106a includes the related graphic generating unit 111 for analyzing the related information for each unit time of the time axis on the basis of an analytical criterion indicating under which condition the related information is analyzed, generating a graphic indicating the related information on the basis of the result of the analysis and preset parameters, and calculating the position coordinates of the graphic indicating the related information. The display control unit 110a performs control to display the graphic indicating the related information on the same screen of the display device 203 on the basis of the calculated position coordinates of the graphic indicating the related information.

As a result, it is possible to display the graphic indicating the related information in addition to the graphic indicating the design value and the graphic indicating the actual value on the same time axis. It is also possible to easily grasp the time-series changes of the design value, the actual value, and the related information for a plurality of target areas on the same screen of the display device.

Moreover, according to the second embodiment, the data acquiring unit 102a acquires a plurality of pieces of related information, and the related graphic generating unit 111 determines whether or not to analyze the second related information on the basis of an analysis result obtained by analyzing the first related information among the plurality of pieces of related information on the basis of an analytical criterion and, in a case where the second related information has been analyzed on the basis of the analytical criterion, generates the graphic indicating the related information on the basis of the analysis result of the second related information and calculates the position coordinates of the graphic indicating the related information.

As a result, related information useful to the user can be appropriately displayed.

Furthermore, according to the second embodiment, the display control unit 110a disposes the graphic indicating the related information at a preset position depending on either the size of the graphic indicating the design value or the size of the graphic indicating the actual value.

As a result, the related information can be displayed in an easily visually recognizable manner.

In addition, according to the second embodiment, the display control unit 110a disposes the graphic indicating the related information at a preset position depending on either the size of the graphic indicating the design value or the size of the graphic indicating the actual value for each unit time of the time axis or for the entire time.

As a result, the related information can be displayed in an easily visually recognizable manner.

Note that, in the second embodiment described above, an operation example has been described in which the related graphic generating unit 111 generates a graphic indicating the related information depending on the number of people present in a target area. However, the operation is not limited to this, and the related graphic generating unit 111 may generate a graphic indicating the related information for all time periods. In this case, the display control unit 110a performs control to display the graphic indicating the related information only for a time period in which there is a person in a target area on the basis of the information indicating a time period in which there is a person in a target area that has been acquired by the data acquiring unit 102a.

### Third Embodiment

In a third embodiment, in addition to the configuration illustrated in the second embodiment described above, the total of display results of a plurality of target areas is displayed in a manner that can be grasped for a long-term. Here, the total of display results of a plurality of target areas refers to, for example, the power consumption of an entire building having a plurality of floors, which is a plurality of target areas. Displaying the total of the display results of a plurality of target areas in a manner that can be grasped for a long-term (hereinafter referred to as a summary display) enables displaying so as to be movable in the time axis direction, displaying a set display period so as to be displayed on one screen of a display device 203, or displaying detailed information for a specific period.

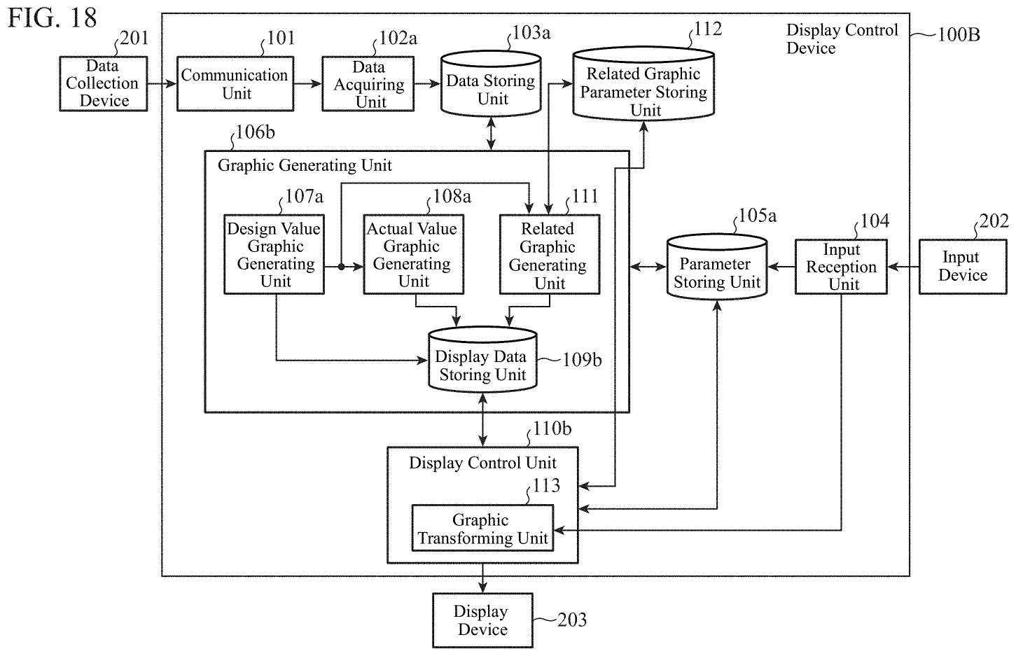

FIG. 18 is a block diagram illustrating the configuration of a display control device 100B according to a third embodiment.

The display control device 100B of the third embodiment is implemented by adding a graphic transforming unit 113 to the display control device 100A illustrated in the second embodiment. Furthermore, instead of the parameter storing unit 105, the graphic generating unit 106a, the design value graphic generating unit 107, the actual value graphic generating unit 108, the display data storing unit 109a, and the display control unit 110a illustrated in the second embodiment, a parameter storing unit 105a, a graphic generating unit 106b, a design value graphic generating unit 107a, an actual value graphic generating unit 108a, a display data storing unit 109b, and a display control unit 110b are included. Note that, in the following description, the same symbol as that used in the second embodiment is provided to the same or a corresponding component as that of the display control device 100A according to the second embodiment, and explanation thereof is omitted or simplified.

The parameter storing unit 105a stores the following parameters in addition to the parameters illustrated in the first embodiment.

Summary display time axis parameter: The unit of the scale of the time axis for summary display.

Enlargement parameter: Magnification ratio when an area designated in graphics indicating the design value and actual value of the whole target areas is enlarged.

In addition, parameters related to the summary display are set in a time axis parameter, a target area parameter, a design value graphic parameter, a threshold value parameter, a width offset parameter, a height offset parameter, and a display parameter described in the first embodiment.

The graphic generating unit 106b includes the design value graphic generating unit 107a, the actual value graphic generating unit 108a, a related graphic generating unit 111, and the display data storing unit 109b.

In addition to the configuration illustrated in the first embodiment, the design value graphic generating unit 107a generates a graphic indicating the total value of the design values of the whole target areas. The design value graphic generating unit 107a sums up the design values of the respective target areas to calculate the design value of the whole target areas. The design value graphic generating unit 107a generates a graphic indicating the design value of the whole target areas for each preset unit time on the basis of the parameters. The design value graphic generating unit 107a calculates the position coordinates of the graphic indicating the design value of the whole target areas that has been generated. The design value graphic generating unit 107a stores the calculated position coordinates of the graphic indicating the design value of the whole target areas and the unit time of the time axis in the display data storing unit 109b and also outputs the calculated position coordinates of the graphic indicating the design value of the whole target areas to the actual value graphic generating unit 108a.

The actual value graphic generating unit 108a generates a graphic indicating the total value of actual values of the target areas in addition to the configuration illustrated in the first embodiment. The actual value graphic generating unit 108a adjusts the graphic indicating the design value of the whole target areas input from the design value graphic generating unit 107a on the basis of the parameters. The actual value graphic generating unit 108a calculates the ratio between the adjusted design value of the whole target areas and the total value of actual values that is indicated by actual value data acquired by the graphic generating unit 106b. The actual value graphic generating unit 108a generates a graphic indicating the actual value of the whole target areas for each preset unit time on the basis of the calculated ratio and the position coordinates of the adjusted graphic indicating the design value of the whole target areas. The actual value graphic generating unit 108a calculates the position coordinates of the graphic indicating the actual value of the whole target areas that has been generated. The actual value graphic generating unit 108a stores the calculated position coordinates of the graphic indicating the actual value of the whole target areas in the display data storing unit 109b.

The display data storing unit 109b is a storage area for storing the position coordinates of graphics indicating the design value of each of the target areas and the total value of design values of the whole target areas that are input from the design value graphic generating unit 107a. The display data storing unit 109b is a storage area for storing the position coordinates of graphics indicating the actual value of each of the target areas and the total value of actual values of the whole target areas that are input from the actual value graphic generating unit 108a. The display data storing unit 109b is a storing area for storing the position coordinates of a graphic indicating the related information.

In addition to the configuration illustrated in the second embodiment, the display control unit 110b performs control to display the graphic indicating the total value of the design values of the whole target areas and the graphic indicating the total value of the actual values of the whole target areas on the display device 203 on the basis of the position coordinates of the graphic indicating the total value of the design values of the whole target areas and the position coordinates of the graphic indicating the total value of the actual values of the whole target areas stored in the display data storing unit 109b. The display control unit 110b performs display control for displaying graphics on the basis of display parameters and an arrangement parameter acquired from the parameter storing unit 105a and display parameters of the related graphic and an arrangement parameter of the related graphic acquired from the related graphic parameter storing unit 112.

The graphic transforming unit 113 performs control to display, on the display device 203, graphics indicating the design value, the actual value, and the related information for each of the target areas for a designated period in response to user operation received by the input reception unit 104.

The graphic transforming unit 113 also performs control of a display on the display device 203 by enlarging a graphic of the designated period and reducing a graphic of periods other than the designated period among the graphics indicating the design value and the actual value of the whole target areas that are displayed in response to the user operation received by the input reception unit 104. Specifically, when a period to be enlarged is designated or selected for the graphics indicating the design value and the actual value of the whole target areas that are displayed, the graphic transforming unit 113 enlarges graphics indicating the design value and the actual value for the whole target areas for the period that has been designated or selected with an enlargement ratio indicated by an enlargement parameter stored in the parameter storing unit 105a.

The graphic transforming unit 113 enlarges the graphics only in the time axis direction. That is, the height of the graphic indicating the design value and the height of the graphic indicating the actual value do not change. Meanwhile, the graphic transforming unit 113 does not particularly enlarge or, as appropriate, reduces periods other than the designated or selected period to be enlarged. The input reception unit 104 allows a specific period to be set to be repeatedly displayed such as “every Wednesday” or “from August to October every year” as input for designating or selecting a period to be enlarged, and there may be a plurality of periods to be enlarged on the time axis. In this case, the graphic transforming unit 113 performs control of a display by applying the magnification ratio to all of the plurality of periods to be repeatedly displayed.

Hardware configuration examples of the display control device 100B will be described. Note that description of the same configuration as that of the first embodiment and the second embodiment is omitted.

The parameter storing unit 105a, the graphic generating unit 106b, the design value graphic generating unit 107a, the actual value graphic generating unit 108a, the display data storing unit 109b, the display control unit 110b, and the graphic transforming unit 113 in the display control device 100B correspond to the processing circuit 100b illustrated in FIG. 2A or the processor 100c that executes a program stored in the memory 100d illustrated in FIG. 2B.

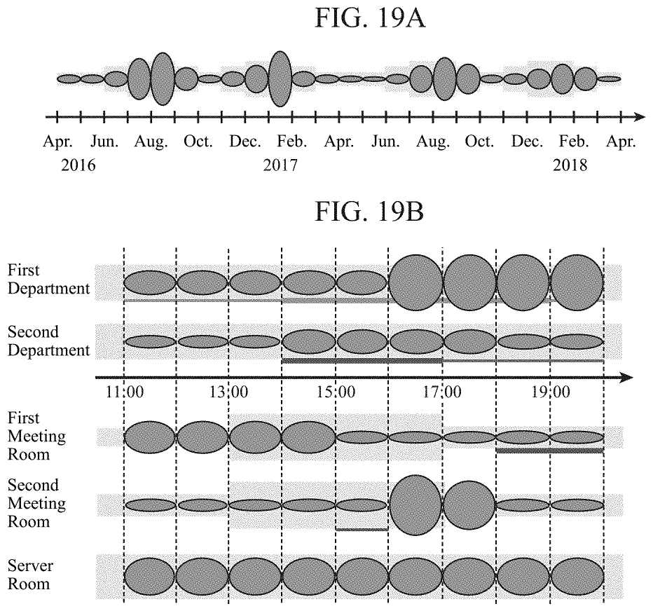

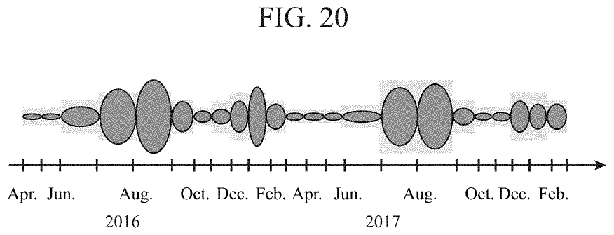

Next, a specific display control example of the display control device 100B is illustrated in FIGS. 19 and 20.

FIGS. 19 and 20 are diagrams illustrating examples of display control of the display control device 100B according to the third embodiment.

Illustrated in FIG. 19 are display examples of graphics indicating the design value and the actual value for the whole target areas and graphics indicating the design value and the actual value for each of the target areas.

FIG. 19A contains the graphics indicating the design value and the actual value for the whole target areas, which illustrates the power consumption of the entire building.

The display period is from April 2016 to March 2018. The display period of the graphics indicating the design value and the actual value of the whole target areas may be the entire period of the information stored in the display data storing unit 109b or may be the period designated by the user. The display control unit 110b converts coordinates so that the graphics indicating the design value and the actual value for the whole target areas are displayed within one screen of the display device 203.

Designating a specific day, week, month, year, etc. on the time axis displayed in FIG. 19A results in displaying graphics indicating the design value, the actual value, and related information for each of the target areas for the designated day, week, month, year, etc. (see FIG. 19B). Note that, in the display of FIG. 19B, as in the first embodiment or the second embodiment, it is possible to perform control to switch whether to display or to hide the graphic indicating the actual value, the graphic indicating the design value, and the graphic indicating the related information for each of the target areas. It is also possible to perform control to switch the drawing order of the graphic indicating the actual value and the graphic indicating the design value and control to move, in the time axis direction, and to display the graphic indicating the design value, the graphic indicating the actual value, and the graphic indicating the related information. The length of one graduation on the time axis or the unit time of the scale on the time axis can be modified.

FIG. 20 is a diagram illustrating an example of display control of the display control device 100B according to the third embodiment.

Illustrated in FIG. 20 are graphics indicating the design value and the actual value for the whole target areas after the enlargement of the graphics illustrated in FIG. 19A.

In FIG. 19A, a case is illustrated in which April 2016 to March 2018 is designated as a display period. In a case where June to October in each year is set as the target of enlargement in the graphics displayed in FIG. 19A, the graphics illustrated in FIG. 20 are displayed. In FIG. 20, in the periods from June to October 2016 and from June to October 2017, the width of a graduation is set longer than that of other periods, and the graphic indicating the design value and the graphic indicating the actual value are enlarged in the time axis direction. That is, the graphic indicating the design value and the graphic indicating the actual value are enlarged only in the lateral width, and the longitudinal width does not change. The graphic transforming unit 113 transforms the coordinates of each of the graphics so that the graphics illustrated in FIG. 19A are transformed into the graphics illustrated in FIG. 20.

Next, the operation of the display control device 100B will be described.

Note that the operation of the display control device 100B as a whole is similar to that of the second embodiment, and thus description thereof will be omitted.

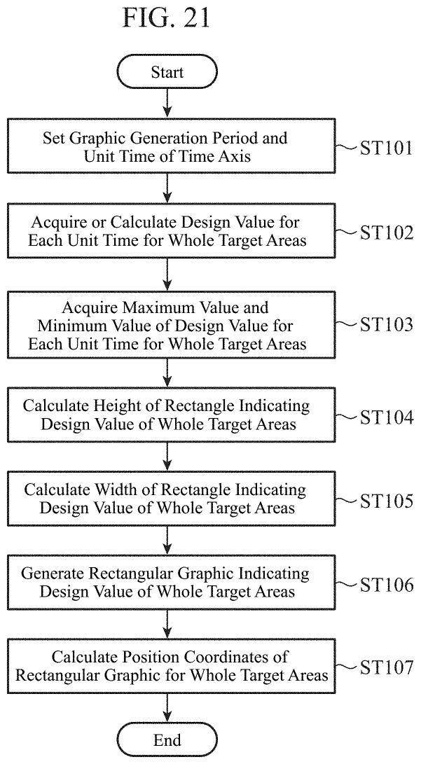

FIG. 21 is a flowchart illustrating the operation of the design value graphic generating unit 107a of the display control device 100B according to the third embodiment.

Of the operation of the design value graphic generating unit 107a described in step ST4 and step ST5 of the flowchart of FIG. 12, a process of generating the graphics indicating the design value and the actual value for the whole target areas will be described by referring to FIG. 21.

The design value graphic generating unit 107a sets a period for which the graphics are to be generated and the unit time of the time axis on the basis of the target period parameter and the summary display time axis parameter acquired by the graphic generating unit 106b (step ST101). The design value graphic generating unit 107a acquires or calculates the design value for the whole target areas for each unit time using design value data of each of the target areas (step ST102). In the example of FIG. 20, the design value of the power consumption of the entire building for each unit time is acquired or calculated. Note that, in a case where there is design value data for the whole target areas, the design value for the whole target areas for each unit time is acquired or calculated from the design value data. The design value graphic generating unit 107a acquires the maximum value and the minimum value of the design values of the whole target areas for each unit time that have been acquired in step ST102 (step ST103).

The design value graphic generating unit 107a calculates the height of a rectangle indicating the design value for the whole target areas for each unit time so that the maximum value and the minimum value of the design value acquired in step ST103 are within a range of a parameter related to the summary display of a design value graphic parameter acquired by the graphic generating unit 106b (step ST104). The design value graphic generating unit 107a calculates the width of the rectangle on the basis of a maximum number of graduations parameter acquired by the graphic generating unit 106 (step ST105). The design value graphic generating unit 107a generates a rectangular graphic indicating the design value for the whole target areas on the basis of the height of the rectangle calculated in step ST104 and the width of the rectangle calculated in step ST105 (step ST106).

The design value graphic generating unit 107a calculates the position coordinates of the rectangular graphic indicating the design value for the whole target areas that has been generated in step ST106, stores the position coordinates in the display data storing unit 109b, outputs the position coordinates to the actual value graphic generating unit 108a, and ends the process (step ST107).

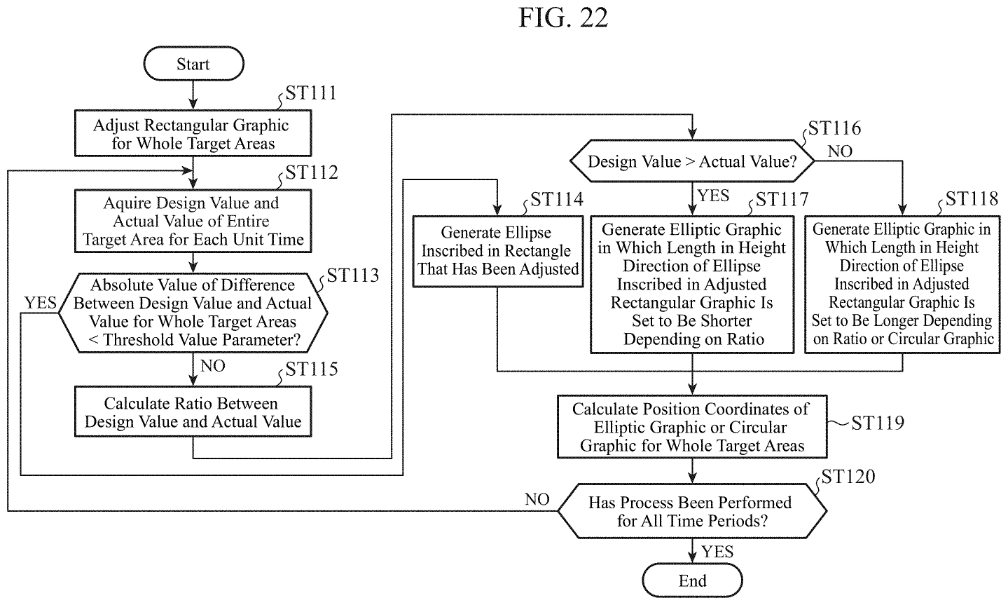

FIG. 22 is a flowchart illustrating the operation of the actual value graphic generating unit 108a of the display control device 100B according to the third embodiment.

Of the operation of the actual value graphic generating unit 108a described in step ST6 and step ST7 of the flowchart of FIG. 12, a process of generating the graphics indicating the design value and the actual value for the whole target areas will be described by referring to FIG. 22.

The actual value graphic generating unit 108a adjusts the rectangular graphic indicating the design value of the whole target areas on the basis of the position coordinates of the rectangular graphic indicating the design value for the whole target areas input from the design value graphic generating unit 107a, a width offset parameter, and a height offset parameter (step ST111).

The actual value graphic generating unit 108a acquires the design value and the actual value for the whole target areas for each unit time using design value data and actual value data for each of the target areas acquired by the graphic generating unit 106b (step ST112). In the example of FIG. 20, the design value and the actual value of the power consumption of the entire building for each unit time are acquired. Note that, in a case where there are design value data and actual value data for the whole target areas, the design value for the whole target areas for each unit time is acquired or calculated from the design value data and the actual value data.

The actual value graphic generating unit 108a compares the absolute value of the difference between the design value and the actual value acquired in step ST112 with a parameter related to the summary display of a threshold value parameter and determines whether or not the absolute value of the difference between the design value and the actual value is less than the parameter related to the summary display of the threshold value parameter (step ST113). If the absolute value of the difference between the design value and the actual value is less than the threshold value parameter (step ST113: YES), the actual value graphic generating unit 108a generates an elliptical graphic inscribed in the rectangular graphic adjusted in step ST111 (step ST114). On the other hand, if the absolute value of the difference between the design value and the actual value is not less than the threshold value parameter (step ST113: NO), the actual value graphic generating unit 108a calculates the ratio between the design value and the actual value (step ST115).

The actual value graphic generating unit 108a determines whether or not the design value is larger than the actual value (step ST116). If the design value is larger than the actual value (step ST116: YES), the actual value graphic generating unit 108a generates an elliptical graphic in which the length in the height direction of the ellipse inscribed in the rectangular graphic adjusted in step ST111 is shortened depending on the ratio calculated in step ST114 (step ST117).

On the other hand, if the design value is not larger than the actual value (step ST116: NO), the actual value graphic generating unit 108a generates an elliptical graphic in which the length in the height direction of the ellipse inscribed in the rectangular graphic adjusted in step ST111 is elongated depending on the ratio calculated in step ST115 or a circular graphic (step ST118).

The actual value graphic generating unit 108a calculates the position coordinates of the elliptical graphic or the circular graphic generated in step ST114, step ST117, or step ST118 and stores the position coordinates in the display data storing unit 109b (step ST119). The actual value graphic generating unit 108a determines whether or not the process has been performed for all the time periods (step ST120). If the process has not been performed for the entire time for the target area that is being processed (step ST120: NO), the actual value graphic generating unit 108a returns to the process of step ST112 and repeats the above-described process. On the other hand, if the process has been performed for the entire time (step ST120: YES), the actual value graphic generating unit 108a ends the process.

Note that, as in the first embodiment, the actual value graphic generating unit 108a may calculate the size of the graphic indicating the actual value on the basis of the ratio of the actual value to the design value.

In addition to the display process described in the second embodiment, the display control unit 110b performs the process of step ST52, which has been described in the flowchart of FIG. 15 of the second embodiment, on the rectangular graphic indicating the design value and the elliptical graphic or the circular graphic indicating the actual value for the whole target areas. As a result, the graphics illustrating the design value and the actual value of the whole target areas illustrated in FIG. 19A are displayed.

Next, the operation will be described in a case where a period to be enlarged is designated or selected for the graphics indicating the design value and the actual value for the whole target areas that are displayed on the display device 203.

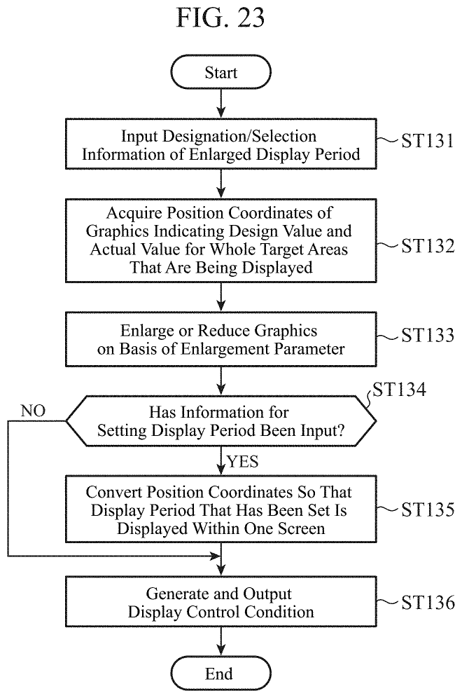

FIG. 23 is a flowchart illustrating the operation of the graphic transforming unit 113 of the display control device 100B according to the third embodiment.

The graphic transforming unit 113 accepts input of information for designating or selecting a period to be enlarged from the input reception unit 104 (step ST131). The graphic transforming unit 113 acquires the position coordinates of the graphics indicating the design value and the actual value for the whole target areas that are currently under display control by the display control unit 110b from the display data storing unit 109b (step ST132). The graphic transforming unit 113 converts the position coordinates acquired in step ST132 so that graphics in the period designated or selected on the basis of an enlargement parameter stored in the parameter storing unit 105a are enlarged and that graphics in other periods are reduced (step ST133).

The graphic transforming unit 113 determines whether or not information for setting the display period has been input via the input reception unit 104 (step ST134). If no information for setting the display period has been input (step ST134: NO), the graphic transforming unit 113 proceeds to the process of step ST136. On the other hand, if information for setting the display period has been input (step ST134: YES), the graphic transforming unit 113 converts the position coordinates of the graphics indicating the design value and the actual value of the whole target areas so that the set display period is displayed within one screen of the display device 203 (step ST135). The graphic transforming unit 113 generates a display control condition of the graphic of the position coordinates converted in step ST133 or step ST134, outputs the display control condition to the display device 203 (step ST136), and ends the process.

Note that, in the third embodiment described above, the case has been described in which the graphics indicating the design value and the actual value for the whole target areas and the graphics indicating the design value and the actual value for each of the target areas are displayed. However, it is not limited to this configuration, and the display control unit 110b may perform display control by selecting one of displaying only the graphics indicating the design value and the actual value for the whole target areas, displaying the graphics indicating the design value and the actual value for each of the target areas, or displaying graphics indicating the design value and the actual value for the whole target areas as well as the graphics indicating the design value and the actual value for each of the target areas.

As described above, according to the third embodiment, the graphic generating unit 106b generates the graphic indicating the total value of the design values and the graphic indicating the total value of the actual values in the plurality of target areas, and the display control unit 110b performs control to display, on the same screen of the display device 203, the graphic indicating the total value of the design values of the plurality of target areas and the graphic indicating the total value of the actual values of the plurality of target areas that have been generated. Therefore, the total value of the design values of the target areas and the total value of the actual values of the target areas can be grasped on the same screen as the screen displaying the design value for each of the target areas and the actual value for each of the target areas.

In addition, further included according to the third embodiment is the graphic transforming unit 113 for performing control to display by enlarging a graphic of a designated period among the graphics indicating the total value of the design values and the total value of the actual values of the plurality of target areas that are currently under display control and reducing a graphic of a period other than the designated period. Therefore, the user can enlarge a graphic of a period that the user intends to check in detail in the graphics indicating the total value of the design values of the target areas and the total value of the actual values of the target areas. As a result, appropriate information can be provided to the user.

Note that, in the above-described third embodiment, the configuration has been described in which the graphic transforming unit 113 is added to the display control device 100A of the second embodiment; however, the graphic transforming unit 113 may be applied to the display control device 100 of the first embodiment.

Note that, in the first to third embodiments described above, the configuration has been described in which various types of data measured by a sensor or the like, such as the power consumption and various types of indoor and outdoor data, are acquired from the data collection device 201 via a network. However, the configuration is not limited to this, and the display control devices 100, 100A, and 100B may read various types of data directly from a medium such as a USB or a DVD without passing through a network. Alternatively, the display control devices 100, 100A and 100B may read various types of data stored in an external or internal storage area. Further alternatively, in a case where various types of data can be acquired from an external website such as the temperature, the display control devices 100, 100A, and 100B may acquire data from the external website without passing through the data collection device 201.

Meanwhile, in the above-described first to third embodiments, the case has been described in which the graphic indicating the design value is a rectangle and the graphic indicating the actual value is an ellipse or a circle; however, the graphics are not limited to a rectangle, an ellipse, or a circle. Any shape can be applied as long as two graphics can be distinguished when the graphic indicating the design value and the graphic indicating the actual value are superimposed.

Moreover, the case where the graphic indicating the related information is a line segment has been described in the second and third embodiments described above; however, the graphic is not limited to a line segment and may be any shape as long as the shape can be distinguished from the graphic indicating the design value and the graphic indicating the actual value. In this case, the setting of the thickness of the line segment graphic illustrated in step ST94 of the flowchart illustrated in FIG. 16 is replaced with the setting of the height of the graphic.

Furthermore, in the above-described first to third embodiments, the case where the power consumption of each of the target areas is displayed in order to visualize the power consumption state of the building has been described as an example; however, the state information is not limited to the power consumption and may be set desirably.

In addition, in the above-described first to third embodiments, it has been described that the display control devices 100, 100A, and 100B include the data storing units 103 and 103a, the parameter storing units 105 and 105a, the display data storing units 109, 109a, and 109b, and the related graphic parameter storing units 112; however, these storage areas may be external to the display control devices 100, 100A, and 100B.

### INDUSTRIAL APPLICABILITY

It is preferable to apply the technology according to the present invention to, for example, systems for monitoring the state of a monitoring target such as a monitoring system for monitoring the power consumption of a building, for example.

### REFERENCE SIGNS LIST

100, 100A, 100B: display control device, 101: communication unit, 102, 102a: data acquiring unit, 103, 103a: data storing unit, 104: input reception unit, 105, 105a: parameter storing unit, 106, 106a, 106b: graphic generating unit, 107, 107a: design value graphic generating unit, 108, 108a: actual value graphic generating unit, 109, 109a, 109b: display data storing unit, 110, 110a, 110b: display control unit, 111: related graphic generating unit, 112: related graphic parameter storing unit, 113: graphic transforming unit

1. A display control device comprising:
processing circuitry performing a process of:
acquiring a design value indicating a value as a control target and an actual value indicating an actual measurement value for state information indicating states of a plurality of target areas;
generating a graphic indicating the design value and generating a graphic indicating the actual value on a basis of position coordinates of the generated graphic indicating the design value; and
performing control to display the graphic indicating the design value and the graphic indicating the actual value generated on a same screen of a display device for each of the target areas,
wherein the process generates the graphic indicating the design value and the graphic indicating the actual value using graphics that allow shapes of the graphic indicating the design value and the graphic indicating the actual value to be distinguished from each other when the graphic indicating the design value and the graphic indicating the actual value are superimposed and displayed while centers of gravity are matched.

2. The display control device according to claim 1,
wherein the process includes:
generating the graphic indicating the design value by calculating a height of the graphic indicating the design value so that a maximum value and a minimum value of the design value are within a range of a preset parameter for each unit time of a time axis to be displayed and calculating a width of the graphic indicating the design value depending on the unit time of the time axis and calculating position coordinates of the generated graphic indicating the design value; and
calculating position coordinates of the graphic indicating the actual value using the position coordinates of the graphic indicating the design value for each unit time of the time axis on a basis of a difference between the design value and the actual value or a ratio of the actual measurement value to the design value,
wherein the process performs control to display the graphic indicating the design value and the graphic indicating the actual value for each of the target areas on a basis of the position coordinates of the graphic indicating the design value calculated and the position coordinates of graphic indicating the actual value calculated.

3. The display control device according to claim 2, wherein the process calculates a size of the graphic indicating the actual value on a basis of a ratio of the actual value to the design value in a case where the difference between the design value and the actual value is larger than a preset threshold value.

4. The display control device according to claim 2, wherein the process calculates a size of the graphic indicating the actual value on a basis of a ratio of the actual value to the design value.

5. The display control device according to claim 1,
wherein the process acquires related information related to the design value and the actual value,
the process includes analyzing the related information on a basis of an analytical criterion indicating under which condition the related information is to be analyzed for each unit time of the time axis, generating a graphic indicating the related information on a basis of a result of the analysis and a preset parameter, and calculating position coordinates of the graphic indicating the related information, and
the process performs control to display the graphic indicating the related information on a same screen of the display device on a basis of the position coordinates of the graphic indicating the related information calculated.

6. The display control device according to claim 5,
wherein the process acquires a plurality of pieces of the related information, and
the process determines whether or not to analyze second related information on a basis of an analysis result obtained by analyzing first related information among the plurality of pieces of the related information on a basis of the analytical criterion and, in a case where the second related information has been analyzed on a basis of the analytical criterion, generates the graphic indicating the related information on a basis of the analysis result of the second related information and calculates the position coordinates of the graphic indicating the related information.

7. The display control device according to claim 5, wherein the process disposes the graphic indicating the related information at a preset position depending on either a size of the graphic indicating the design value or a size of the graphic indicating the actual value.

8. The display control device according to claim 7, wherein the process disposes the graphic indicating the related information at a preset position depending on either the size of the graphic indicating the design value or the size of the graphic indicating the actual value for each unit time of the time axis or for entire time.

9. The display control device according to claim 1,
wherein the process generates a graphic indicating a total value of the design values and a graphic indicating a total value of the actual values in a plurality of the target areas, and
the process performs control to display the graphic indicating the total value of the design values for the plurality of target areas and the graphic indicating the total value of the actual values of the plurality of target areas generated on a same screen of the display device.

10. The display control device according to claim 5,
wherein the process generates a graphic indicating a total value of the design values and a graphic indicating a total value of the actual values in a plurality of the target areas, and
the process performs control to display the graphic indicating the total value of the design values for the plurality of target areas and the graphic indicating the total value of the actual values of the plurality of target areas generated on a same screen of the display device.

11. The display control device according to claim 9, the process further including performing control of a display by enlarging a graphic of a designated period among the graphics indicating the total value of the design values and the total value of the actual values of the plurality of target areas that are under display control and reducing a graphic of a period other than the designated period.

12. The display control device according to claim 10, the process further including performing control of a display by enlarging a graphic of a designated period among the graphics indicating the total value of the design values and the total value of the actual values of the plurality of target areas that are under display control and reducing a graphic of a period other than the designated period.

13. A display control method comprising:
acquiring a design value indicating a value as a control target and an actual value indicating an actual measurement value for state information indicating states of a plurality of target areas;
generating a graphic indicating the design value and generating a graphic indicating the actual value on a basis of position coordinates of the generated graphic indicating the design value using graphics that allow shapes of the graphic indicating the design value and the graphic indicating the actual value to be distinguished from each other when the graphic indicating the design value and the graphic indicating the actual value are superimposed and displayed while centers of gravity are matched; and
performing control to display the graphic indicating the design value and the graphic indicating the actual value that have been generated on a same screen of a display device for each of the target areas.
